(19) United States
(12) Patent Application Publication
(10) Pub. No.: US 2009/0203530 A1
(43) Pub. Date: Aug. 13, 2009

(54) Polymer evolution via templated synthesis

(76) Inventors: David R. Liu, Lexington, MA (US); Daniel M. Rosenbaum, Burlingame, CA (US); Yevgeny Brudno, Cambridge, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 11/916,710

(22) PCT Filed: Jun. 7, 2006
(86) PCT No.: PCT/US06/22207

§ 371 Date: Sep. 8, 2008

Related U.S. Application Data
(60) Provisional application No. 60/688,165, filed on Jun. 7, 2005.

(51) Int. Cl. C40B 10/00; C40B 30/00

(52) U.S. Cl. 506/1; 506/7

(57) ABSTRACT

The invention provides a method for producing polymers having a desirable property, for example, catalytic activity or binding activity, via evolutionary nucleic acid-mediated chemistry.

### RELATED APPLICATIONS

This application claims the benefit of and priority to U.S. Patent Application Ser. No. 60/688, 165, filed Jun. 7, 2005, the entire disclosure of which is incorporated by reference herein for all purposes.

### FIELD OF THE INVENTION

The invention relates generally to polymer synthesis, and more particularly relates to evolutionary polymer synthesis by nucleic acid-mediated chemistry.

### BACKGROUND OF THE INVENTION

Directed evolution minimally requires (i) the high-fidelity translation of a replicable information carrier such as DNA into the evolving molecules, (ii) a stable linkage between the translated molecules and their encoding information carriers, (iii) a selection that separates functional molecules from non-functional variants, and (iv) the mutation, re-translation, and re-selection of molecules surviving the initial selection. Although ribosomes or polymerase enzymes are used to meet the first requirement during protein or nucleic acid evolution, these enzymes cannot be used to generate synthetic polymers that are not close analogues of DNA, RNA, or proteins.

Under certain circumstances it may be helpful to produce polymers having a desirable property. These properties may include, for example, improved catalytic activity, improved binding activity, improved stability, improved solubility and the like. The improvement of these properties has been difficult to achieve using conventional chemistries. Accordingly, there is an ongoing need for new methods of making polymers with the desired properties.

### SUMMARY OF THE INVENTION

The invention provides a variety of methods and compositions that expand the scope of template-directed synthesis, selection, amplification and evolution of molecules of interest. In particular, the invention provides an in vitro method for evolving synthetic polymers of interest using nucleic acid templated chemistry. Using the approaches described herein, a skilled artisan may produce polymers having an improved property of interest, for example, catalytic activity, biological activity, or binding activity to a target of interest.

In one aspect, the invention provides an in vitro method for evolving a polymer having a particular property. The method comprises the steps of: (a) producing a mixture of polymers, wherein each polymer is associated with a template oligonucleotide that encoded its synthesis; (b) selecting from the mixture produced in step (a) a polymer having a particular property, wherein the selected polymer is associated with the template that encoded its synthesis; (c) obtaining information about the sequence of the template associated with the polymer selected in step (b); (d) producing a plurality of evolved templates, each of which differs by at least one base from the template associated with the polymer selected in step (b); (e) producing a mixture of evolved polymers using the evolved templates, wherein each evolved polymer is associated with the template that encoded its synthesis; and (f) selecting from the mixture produced in step (e) an evolved polymer having the particular property.

In another aspect, the invention provides an in vitro method for evolving a polymer having a particular property. The method comprises the steps of: (a) combining (i) a plurality of different templates, wherein each template comprises a first codon and a second codon, with (ii) a plurality of transfer units, at least one of which comprises a monomeric subunit associated with an oligonucleotide having a first anti-codon capable of annealing to the first codon of a given template and at least one of which comprises a different monomeric subunit associated with an oligonucleotide comprising a second anti-codon capable of annealing to the second codon of a given template under conditions to permit transfer units to anneal to a particular template and to permit at least one monomer subunit to become covalently linked to a different monomer subunit to produce a polymer associated with the template that encoded its synthesis; (b) selecting a polymer having a particular property, wherein the polymer remains associated with the template that encoded its synthesis; (c) obtaining sequence information about the template associated with the polymer selected in step (b); (d) obtaining a plurality of evolved templates that contain a codon that differs by at least one base from the template associated with the polymer selected in step (b); (e) combining (i) the plurality of evolved templates with (ii) a plurality of transfer units under conditions to permit transfer units to anneal to a particular template and to permit a first monomer subunit to become covalently linked to a second monomer subunit to produce an evolved polymer associated with the evolved template that that encoded its synthesis; and (e) selecting an evolved polymer having the particular property.

In step (a), the polymer can be covalently attached to the template oligonucleotide. Furthermore, in step (e), the polymer can be covalently attached to the template oligonucleotide. It is contemplated that the method of the invention may be used to develop a variety of different polymers. It is understood, however, that the claimed method may be useful in evolving peptidyl nucleic acid (PNA) polymers.

Under certain circumstances, for example, in order to perform a selection process that exploits binding activity, it may be advantageous to permit the polymer to fold. For example, when the polymer is a PNA polymer, it may be advantageous to disassociate the PNA polymer from the template that encoded its synthesis prior to selection. This can be achieved by using an oligonucleotide complementary to the template to disassociate the polymer from the template.

In another aspect, the invention provides a method of selecting a polymer capable of binding to a target molecule. The methods comprises the: (a) combining a plurality of polymers associated with oligonucleotide templates that encoded their synthesis with a solid support having the target molecule disposed thereon under conditions to permit polymers to bind to the target molecule; (b) removing unbound polymers; (c) disassociating the bound polymers from the solid support to produce a first fraction enriched for polymers that bind to the target molecule; (d) combining the disassociated polymers with a fresh solid support having the target molecule disposed therein under conditions to permit polymers to bind to the target molecule; (e) removing unbound polymers; and (f) disassociating the bound polymers from the solid support to provide a second fraction enriched for polymers that bind to the target molecule, wherein the second fraction contains a greater proportion of polymers that bind to the target than the first fraction.

Improved yields of enriched polymer can be obtained by, for example, in step (d), combining fresh solid support with the disassociated polymer in the presence of the solid support used in step (a). This approach obviates the step of separating the selected polymer from the solid support. This, therefore, reduces losses that can be incurred when the polymer is harvested and transferred to another container. This approach can be helpful when the polymer is a PNA molecule.

### DEFINITIONS

The term, “associated with” as used herein describes the interaction between or among two or more groups, moieties, compounds, monomers, etc. When two or more entities are “associated with” one another as described herein, they are linked by a direct or indirect covalent or non-covalent interaction. Preferably, the association is covalent. The covalent association may be, for example, but without limitation, through an amide, ester, carbon-carbon, disulfide, carbamate, ether, thioether, urea, amine, or carbonate linkage. The covalent association may also include a linker moiety, for example, a photocleavable linker. Desirable non-covalent interactions include hydrogen bonding, van der Waals interactions, dipole-dipole interactions, pi stacking interactions, hydrophobic interactions, magnetic interactions, electrostatic interactions, etc.

The terms, “polynucleotide,” “nucleic acid”, or “oligonucleotide” as used herein refer to a polymer of nucleotides. The polymer may include, without limitation, natural nucleosides (i.e., adenosine, thymidine, guanosine, cytidine, uridine, deoxyadenosine, deoxythymidine, deoxyguanosine, and deoxycytidine), nucleoside analogs (e.g., 2-aminoadenosine, 2-thiothymidine, inosine, pyrrolo-pyrimidine, 3-methyl adenosine, 5-methylcytidine, C5-bromouridine, C5-fluorouridine, C5-iodouridine, C5-propynyl-uridine, C5-propynyl-cytidine, C5-methylcytidine, 7-deazaadenosine, 7-deazaguanosine, 8-oxoadenosine, 8-oxoguanosine, O(6)-methylguanine, and 2-thiocytidine), chemically modified bases, biologically modified bases (e.g., methylated bases), intercalated bases, modified sugars (e.g., 2′-fluororibose, ribose, 2′-deoxyribose, arabinose, and hexose), or modified phosphate groups (e.g., phosphorothioates and 5′-N-phosphoramidite linkages). Nucleic acids and oligonucleotides may also include other polymers of bases having a modified backbone, such as a locked nucleic acid (LNA), a peptide nucleic acid (PNA), a threose nucleic acid (TNA) and any other polymers capable of serving as a template for an amplification reaction using an amplification technique, for example, a polymerase chain reaction, a ligase chain reaction, or non-enzymatic template-directed replication.

The term, “transfer unit” as used herein, refers to a molecule comprising an oligonucleotide having an anti-codon sequence associated with a monomer subunit useful in template mediated polymer synthesis.

The term, “template” as used herein, refers to a molecule comprising an oligonucleotide having at least one codon sequence suitable for a template mediated chemical synthesis. The template optionally may comprise (i) a plurality of codon sequences, (ii) an amplification means, for example, a PCR primer binding site or a sequence complementary thereto, (iii) a reactive unit associated therewith, (iv) a combination of (i) and (ii), (v) a combination of (i) and (iii), (vi) a combination of (ii) and (iii), or a combination of (i), (ii) and (iii).

The terms, “codon” and “anti-codon” as used herein, refer to complementary oligonucleotide sequences in the template and in the transfer unit, respectively, that permit the transfer unit to anneal to the template during template mediated chemical synthesis.

Throughout the description, where compositions are described as having, including, or comprising specific components, or where processes are described as having, including, or comprising specific process steps, it is contemplated that compositions of the present invention also consist essentially of, or consist of, the recited components, and that the processes of the present invention also consist essentially of, or consist of, the recited processing steps. Further, it should be understood that the order of steps or order for performing certain actions are immaterial so long as the invention remains operable. Moreover, two or more steps or actions may be conducted simultaneously.

### DESCRIPTION OF THE DRAWINGS

FIG. 1 is a schematic representation of nucleic acid mediated polymer synthesis.

FIG. 2 depicts a schematic representation of in vitro synthetic polymer evolution using nucleic acid-templated organic synthesis.

FIG. 3A depicts DNA-templated polymerization, in which ten consecutive DNA-templated reductive amination couplings resulted in PNA 40-mers containing secondary amine linkages between every fourth nucleotide. The efficiency of this process for all nine PNA aldehydes of the form H₂N-gvvt-CHO (where v=a, c, or g) to generate predominantly full length synthetic polymer products is shown by denaturing PAGE. FIG. 3B depicts an experiment in which an equimolar mixture of nine gvvt building blocks was combined with a library of 3.5×10⁹ DNA templates to yield a library of PNA covalently linked to their DNA templates, as shown by denaturing PAGE. The library polymerization reactions contained 4.4, 8.8, or 16.2 equivalents of all nine gvvt PNA aldehyde building blocks.

FIG. 4 depicts in vitro selection of a synthetic polymer library for papain binding activity. FIG. 4A shows displacement of the PNA strand from translated PNA-DNA conjugates (see FIG. 2). FIG. 4B depicts an agarose gel electrophoresis of PCR-amplified DNA templates surviving each of four successive rounds of papain affinity selection. FIG. 4C depicts template sequences resulting from in vitro selection of the PNA library. The variable bases of the most highly represented sequence (P1) emerging from the selection are outlined. FIG. 4D depicts a hypothetical model of P1 secondary structure based on the predicted structure of the corresponding RNA at 1 M simulated salt concentration.

FIG. 5 depicts enrichment assays in which synthetic polymers were selected using papain affinity selection. FIG. 5A depicts papain affinity selection of the translation products of a 500:1 mixture of M1 (mutant):P1 (selected sequence) templates, and of a 500:1 mixture of U1 (unrelated):P1 templates. Based on the unique restriction digest patterns of M1, P1, and U1, the selection enriches the P1 translation product 500-fold, but not the M1 or U1 products. FIG. 5B depicts the results of a fluorescence polarization-based papain binding assay of truncated P1 PNA (data points connected by a solid line) versus M1 PNA or P1 DNA or BFL-amine alone (data points for each are not connected by a line), all prepared by solid-phase synthesis and labelled at their amino termini with BODIPY-fluorescein (BFL) succinimidyl ester. This graph shows the ability of the selected synthetic polymer to bind papain in the absence of its DNA template. FIG. 5C depicts results of binding assays of the BFL-labelled truncated P1 PNA with papain (data points connected by a solid line) versus with lysozyme or with trypsin (data points for each are not connected by a line), and reveals that the P1 PNA does not bind lysozyme or trypsin with detectable affinity. Error bars in FIGS. 5B and 5C represent standard deviations of three or more independent trials.

FIG. 6 depicts an experiment in which diversification of P1, retranslation, and reselection yields P2, a synthetic polymer with improved papain affinity. FIG. 6A shows the five positions (corresponding to ‘v’ in 2nd library) at which P1 was diversified into a second-generation library. The clones emerging from papain affinity selection of the second library are shown. The most highly represented sequence (P2) converges on the sequences outlined. FIG. 6B depicts the origins and hypothetical secondary structure model of the P2 PNA. FIG. 6C depicts the results of a fluorescence polarization-based papain binding assay of BFL-labelled truncated P2 PNA (data points connected by a solid line) compared with BFL-labelled truncated P1 PNA (data points connected by a dashed line) and BFL-amine alone (data points not connected by a line). FIG. 6D depicts the results of a binding assay in which P2 was pre-incubated with 10 equivalents of either a complementary DNA 18-mer (data points connected by a dashed line) or a control DNA 18-mer containing the P2-complementary codons in a scrambled order (data points connected by a solid line), showing that P2 binding to papain is inhibited by DNA complementary to P2. Error bars in FIGS. 6C and 6D represent standard deviations of three or more independent trials.

FIG. 7 depicts typical PAGE results showing PNA displacement of an individual translated double-hairpin template. Addition of the restriction endonuclease Sph I exclusively cleaves double-stranded DNA in the template (lane 1=template×Sph I; lane 2=“filled in” template using DNA polymerase×Sph I; lane 3=translation product×Sph I; lane 4=translated and displacement product×Sph I). The presence of the fast-running band in both lane 2 and lane 4 represents cleaved double-stranded DNA in both the positive control (lane 2) and in the translated and displaced product (lane 4).

FIG. 8 is a schematic representation of an approach for reducing out-of-frame codon and anti-codon annealing during templated synthesis.

FIG. 9 shows exemplary coupling chemistries useful in nucleic acid-mediated polymerization reactions.

### DESCRIPTION OF CERTAIN EMBODIMENTS OF THE INVENTION

Nucleic acid templated synthesis as described herein permits the production, selection, amplification and evolution of a broad variety of non-natural polymers. The invention is particularly useful for synthesizing non-naturally occurring polymers. For example, the invention can be used to synthesize non-biological polymers (e.g., polymers other than DNA, RNA, or protein). In nucleic acid-mediated synthesis, the information encoded by a DNA or other nucleic acid sequence is translated into the synthesis of a reaction product. The nucleic acid template typically comprises a plurality of coding regions which anneal to complementary anti-codon sequences associated with reactive units, thereby bringing the reactive units together in a sequence-specific manner to create a reaction product. Since nucleic acid hybridization is sequence-specific, the result of a nucleic acid-templated reaction is the translation of a specific nucleic acid sequence into a corresponding reaction product.

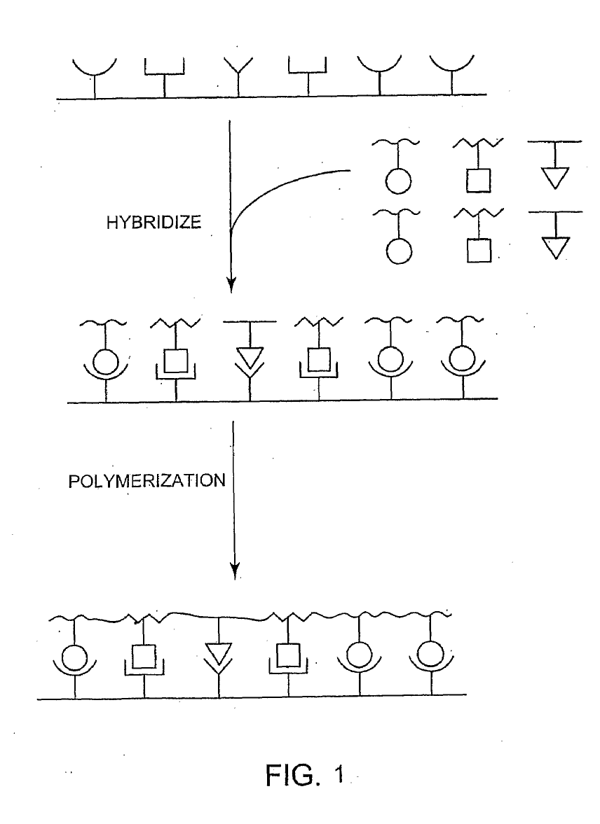

A general scheme for polymer synthesis is presented in FIG. 1. As shown in FIG. 1, in this approach the template can bring together, either simultaneously or sequentially, a plurality of transfer units in a sequence-specific manner. The reactive units on each annealed transfer unit can then be reacted with one another in a polymerization process to produce a polymer. Using this approach it is possible to generate a variety of non-natural polymers. The polymerization may be a step-by-step process or may be a simultaneous process whereby all the annealed monomers are reacted in one reaction sequence

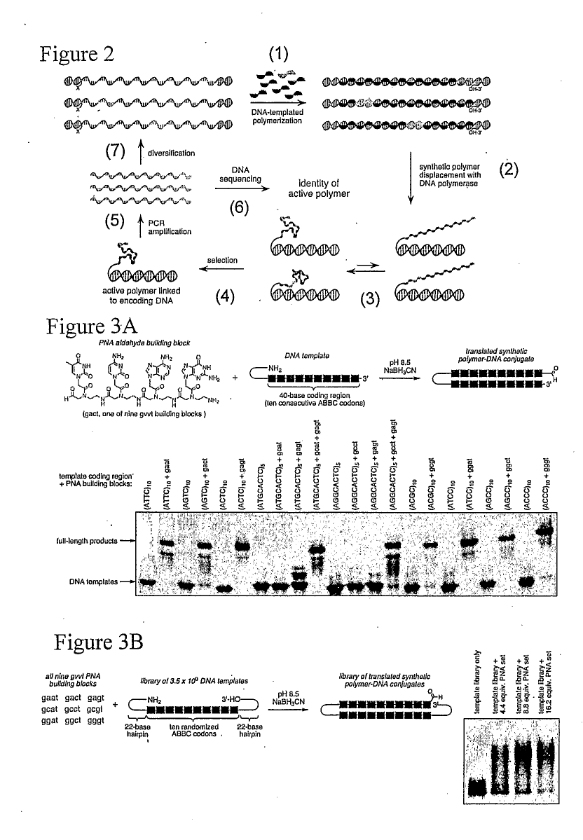

A proposed approach for the evolutionary synthesis of polymers is set forth in FIG. 2. Information transfer from the nucleic acid template to the polymer occurs by template-directed syntheses.

Initially, a plurality of different oligonucleotide templates are provided. When transfer units are combined with the templates under conditions for DNA-templated polymerization, a plurality of polymers are produced, each of which is associated with the template that encoded its synthesis (1). Thereafter, the synthetic polymer is disassociated from the template via a DNA polymerase that synthesizes a strand complementary to the template (2). As shown, the synthetic polymer becomes substantially disassociated from the template that encoded its synthesis but yet still remains attached, for example, covalently attached, to the template. In this example, Watson and Crick-type base pairing between the synthetic polymer and the template is reduced or eliminated. As a result of strand displacement, the polymer is permitted to fold (3). The polymers that bind to a particular target are selected to provide a population of polymers that bind to the target (4). The templates associated with the selected polymer then are amplified, for example, via polymerase chain reaction (PCR) (5). The amplified sequence can then be sequenced to identify and/or show the synthetic history of the polymer of interest (6). Furthermore, the amplified template can be mutated to give another population of templates that can be used for another round of polymer synthesis and selection (7).

### I. Template Considerations

The nucleic acid template can direct a wide variety of chemical reactions without obvious structural requirements by sequence-specifically recruiting reactants linked to complementary oligonucleotides. As discussed, the nucleic acid mediated format permits reactions that may not be possible using conventional synthetic approaches. During synthesis, the template hybridizes or anneals to one or more transfer units to direct the synthesis of a reaction product, which during certain steps of templated synthesis remain associated with the template. A reaction product then is selected or screened based on certain criteria, such as the ability to bind to a preselected target molecule. Once the reaction product has been identified, the associated template can then be sequenced to decode the synthetic history of the reaction product. Furthermore, as will be discussed in more detail below, the template may be evolved to guide the synthesis of another chemical compound or library of chemical compounds.

### (i) Template Format

The template may incorporate a hairpin loop on one end terminating in a reactive unit that can interact with one or more reactive units associated with transfer units. For example, a DNA template can comprise a hairpin loop terminating in a 5′-amino group, which may or may not be protected. The amino group may act as an initiation point for formation of an unnatural polymer.

The length of the template may vary greatly depending upon the type of the nucleic acid-templated synthesis contemplated. For example, in certain embodiments, the template may be from 10 to 10,000 nucleotides in length, from 20 to 1,000 nucleotides in length, from 20 to 400 nucleotides in length, from 40 to 1,000 nucleotides in length, or from 40 to 400 nucleotides in length. The length of the template will of course depend on, for example, the length of the codons, the complexity of the library, the complexity and/or size of a reaction product, the use of spacer sequences, etc.

### (ii) Codon Usage

It is contemplated that the sequence of the template may be designed in a number of ways without going beyond the scope of the present invention. For example, the length of the codon must be determined and the codon sequences must be set. If a codon length of two is used, then using the four naturally occurring bases only 16 possible combinations are available to be used in encoding the library. If the length of the codon is increased to three (the number Nature uses in encoding proteins), the number of possible combinations increases to 64. If the length of the codon is increased to four, the number of possible combinations increases to 256. Other factors to be considered in determining the length of the codon are mismatching, frame-shifting, complexity of library, etc. As the length of the codon is increased up to a certain point the number of mismatches is decreased; however, excessively long codons likely will hybridize despite mismatched base pairs.

Although the length of the codons may vary, the codons may range from 2 to 50 nucleotides, from 2 to 40 nucleotides, from 2 to 30 nucleotides, from 2 to 20 nucleotides, from 2 to 15 nucleotides, from 2 to 10 nucleotides, from 3 to 50 nucleotides, from 3 to 40 nucleotides, from 3 to 30 nucleotides, from 3 to 20 nucleotides, from 3 to 15 nucleotides, from 3 to 10 nucleotides, from 4 to 50 nucleotides, from 4 to 40 nucleotides, from 4 to 30 nucleotides, from 4 to 20 nucleotides, from 4 to 15 nucleotides, from 4 to 10 nucleotides, from 5 to 50 nucleotides, from 5 to 40 nucleotides, from 5 to 30 nucleotides, from 5 to 20 nucleotides, from 5 to 15 nucleotides, from 5 to 10 nucleotides, from 6 to 50 nucleotides, from 6 to 40 nucleotides, from 6 to 30 nucleotides, from 6 to 20 nucleotides, from 6 to 15 nucleotides, from 6 to 10 nucleotides, from 7 to 50 nucleotides, from 7 to 40 nucleotides, from 7 to 30 nucleotides, from 7 to 20 nucleotides, from 7 to 15 nucleotides, from 7 to 10 nucleotides, from 8 to 50 nucleotides, from 8 to 40 nucleotides, from 8 to 30 nucleotides, from 8 to 20 nucleotides, from 8 to 15 nucleotides, from 8 to 10 nucleotides, from 9 to 50 nucleotides, from 9 to 40 nucleotides, from 9 to 30 nucleotides, from 9 to 20 nucleotides, from 9 to 15 nucleotides, from 9 to 10 nucleotides. Codons, however, preferably are 3, 4, 5, 6, 7, 8, 9 or 10 nucleotides in length.

In one embodiment, the set of codons used in the template maximizes the number of mismatches between any two codons within a codon set to ensure that only the proper anti-codons of the transfer units anneal to the codon sites of the template. Furthermore, it is important that the template has mismatches between all the members of one codon set and all the codons of a different codon set to ensure that the anti-codons do not inadvertently bind to the wrong codon set. For example, with regard to the choice of codons n bases in length, each of the codons within a particular codon set should differ with one another by k mismatches, and all of the codons in one codon set should differ by m mismatches with all of the codons in the other codon set. Exemplary values for n, k, and m, for a variety of codon sets suitable for use on a template are published, for example, in Table 1 of U.S. Patent Application Publication No. US-2004/0180412, by Liu et al.

Using an appropriate algorithm, it is possible to generate sets of codons that maximize mismatches between any two codons within the same set, where the codons are n bases long having at least k mismatches between any two codons. Since between any two codons, there must be at least k mismatches, any two subcodons of n−(k−1) bases must have at least one mismatch. This sets an upper limit of 4^{n-k+1} on the size of any (m, k) codon set. Such an algorithm preferably starts with the 4^{n-k+1} possible subcodons of length n−(k−1) and then tests all combinations of adding k−1 bases for those that always maintain k mismatches. All possible (n, k) sets can be generated for n≦6. For n>6, the 4^{n-k+1} upper limits of codons cannot be met and a “full” packing of viable codons is mathematically impossible. In addition to there being at least one mismatch k between codons within the same codon set, there should also be at least one mismatch m between all the codons of one codon set and all the codons of another codon set. Using this approach, different sets of codons can be generated so that no codons are repeated.

By way of example, four (n=5, k=3, m=1) sets, each with 64 codons, can be chosen that always have at least one mismatch between any two codons in different sets and at least three mismatches between codons in the same set, as described, for example, in Tables 2-5 of U.S. Patent Application Publication No. US-2004/0180412, by Liu et al. Similarly, four (n=6, k=4, m=2) sets, each with 64 codons, can be chosen that always have at least two mismatches between any two codons in different codon sets and at least four mismatches between codons in the same codon set as described, for example, in Tables 6-9 of U.S. Patent Application Publication No. US-2004/0180412, by Liu et al.

Codons can also be chosen to increase control over the GC content and, therefore, the melting temperature of the codon and anti-codon. Codons sets with a wide range in GC content versus AT content may result in reagents that anneal with different efficiencies due to different melting temperatures. By screening for GC content among different (m, k) sets, the GC content for the codon sets can be optimized. For example, the four (6, 4, 2) codon sets set forth in Tables 6-9 of U.S. Patent Application Publication No. US-2004-0180412-A1 each contain 40 codons with identical GC content (i.e., 50% GC content). By using only these 40 codons at each position, all the reagents in theory will have comparable melting temperatures, removing potential biases in annealing that might otherwise affect library synthesis. Longer codons that maintain a large number of mismatches such as those appropriate for certain applications such as the reaction discovery system can also be chosen using this approach. For example, by combining two (6, 4) sets together while matching low GC to high GC codons, (12, 8) sets with 64 codons all with 50% GC content can be generated for use in reaction discovery selections as well as other application where multiple mismatches might be advantageous. These codons satisfy the requirements for encoding a 30×30 matrix of functional group combinations for reaction discovery.

Although an anti-codon is intended to bind only to a codon, an anti-codon may also bind to an unintended sequence on a template if complementary sequence is present. Thus, an anti-codon may inadvertently bind to a non-codon sequence. Alternatively, an anti-codon might inadvertently bind out-of-frame by annealing in part to one codon and in part to another codon or to a non-codon sequence. Finally, an anti-codon might bind in-frame to an incorrect codon, an issue addressed by the codon sets described above by requiring at least one base difference distinguishing each codon. In Nature, the problems of noncoding sequences and out-of-frame binding are avoided by the ribosome. The nucleic acid-templated methods described herein, however, do not take advantage of the ribosome's fidelity. Therefore, in order to avoid erroneous annealing, the templates can be designed such that sequences complementary to anti-codons are found exclusively at in-frame codon positions. For example, codons can be designed to begin, or end, with a particular base (e.g., “G”). If that base is omitted from all other positions in the template (i.e., all other positions are restricted to T, C, and A), only perfect codon sequences in the template will be at the in-frame codon sequences. Similarly, the codon may be designed to be sufficiently long such that its sequence is unique and does not appear elsewhere in a template.

When the nucleic acid-templated synthesis is used to produce a polymer, spacer sequences may also be placed between the codons to prevent frame shifting. More preferably, the bases of the template that encode each polymer subunit (the “genetic code” for the polymer) may be chosen from Table 1 to preclude or minimize the possibility of out-of-frame annealing. These genetic codes reduce undesired frameshifted nucleic acid-templated polymer translation and differ in the range of expected melting temperatures and in the minimum number of mismatches that result during out-of-frame annealing.

TABLE 1
Representative Genetic Codes for Nucleic Acid-templated
Polymers That Preclude Out-Of-Frame Annealing

| Sequence | Number of Possible Codons |
|---|---|
| VVNT | 36 possible codons |
| NVVT | 36 possible codons |
| SSWT | 8 possible codons |
| SSST | 8 possible codons |
| SSNT | 16 possible codons |
| VNVNT or NVNVT | 144 possible codons |
| SSSWT or SSWST | 16 possible codons |
| SNSNT or NSNST | 64 possible codons |
| SSNWT or SWNST | 32 possible codons |
| WSNST or NSWST | 32 possible codons |

where, V=A, C, or G, S=C or G, W=A or T, and N=A, C, G, or T

As in Nature, start and stop codons are useful, particularly in the context of polymer synthesis, to restrict erroneous anti-codon annealing to non-codons and to prevent excessive extension of a growing polymer. For example, a start codon can anneal to a transfer unit bearing a small molecule scaffold or a start monomer unit for use in polymer synthesis; the start monomer unit can be masked by a photolabile protecting group. A stop codon, if used to terminate polymer synthesis, should not conflict with any other codons used in the synthesis and should be of the same general format as the other codons. Generally, a stop codon can encode a monomer unit that terminates polymerization by not providing a reactive group for further attachment. For example, a stop monomer unit may contain a blocked reactive group such as an acetamide rather than a primary amine. In other embodiments, the stop monomer unit can include a biotinylated terminus that terminates the polymerization and facilitates purification of the resulting polymer.

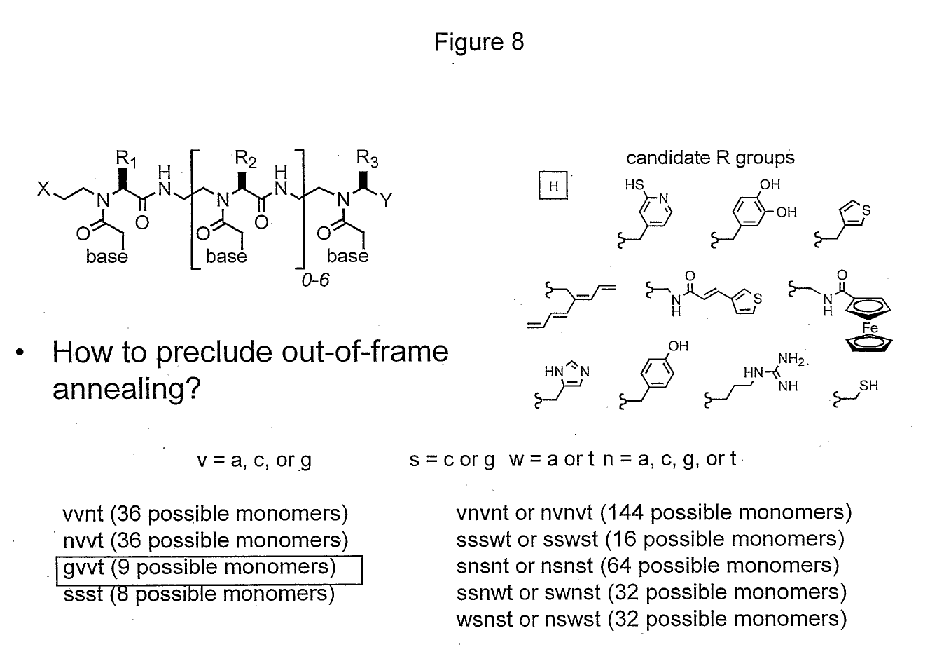

An exemplary approach for minimizing out-of-frame annealing during polymer synthesis is described in FIG. 8.

(iii) Template Synthesis

The templates may be synthesized using methodologies well known in the art. For example, the nucleic acid sequence may be prepared using any method known in the art to prepare nucleic acid sequences. These methods include both in vivo and in vitro methods including PCR, plasmid preparation, endonuclease digestion, solid phase synthesis (for example, using an automated synthesizer), in vitro transcription, strand separation, etc. Following synthesis, the template, when desired may be associated (for example, covalently or non covalently coupled) with a reactive unit of interest using standard coupling chemistries known in the art.

An efficient method to synthesize a large variety of templates is to use a “split-pool” technique. The oligonucleotides are synthesized using standard 3′ to 5′ chemistries. First, the constant 3′ end is synthesized. This is then split into n different vessels, where n is the number of different codons to appear at that position in the template. For each vessel, one of the n different codons is synthesized on the (growing) 5′ end of the constant 3′ end. Thus, each vessel contains, from 5′ to 3′, a different codon attached to a constant 3′ end. The n vessels are then pooled, so that a single vessel contains n different codons attached to the constant 3′ end. Any constant bases adjacent the 5′ end of the codon are now synthesized. The pool then is split into m different vessels, where m is the number of different codons to appear at the next (more 5′) position of the template. A different codon is synthesized (at the 5′ end of the growing oligonucleotide) in each of the m vessels. The resulting oligonucleotides are pooled in a single vessel. Splitting, synthesizing, and pooling are repeated as required to synthesize all codons and constant regions in the oligonucleotides.

### II. Transfer Units

A transfer unit comprises an oligonucleotide containing an anti-codon sequence and a reactive unit. The anti-codons are designed to be complementary to the codons present in the template. Accordingly, the sequences used in the template and the codon lengths should be considered when designing the anti-codons. Any molecule complementary to a codon used in the template may be used, including natural or non-natural nucleotides. In certain embodiments, the codons include one or more bases found in nature (i.e., thymidine, uracil, guanidine, cytosine, and adenine). Thus, the anti-codon can include one or more nucleotides normally found in Nature with a base, a sugar, and an optional phosphate group. Alternatively, the bases may be connected via a backbone other than the sugar-phosphate backbone normally found in Nature (e.g., non-natural nucleotides).

As discussed above, the anti-codon is associated with a particular type of reactive unit to form a transfer unit. The reactive unit may represent a distinct entity or may be part of the functionality of the anti-codon unit. In certain embodiments, each anti-codon sequence is associated with one monomer type. For example, the anti-codon sequence ATTAG may be associated with a carbamate residue with an isobutyl side chain, and the anti-codon sequence CATAG may be associated with a carbamate residue with a phenyl side chain. This one-for-one mapping of anti-codon to monomer units allows the decoding of any polymer of the library by sequencing the nucleic acid template used in the synthesis and allows synthesis of the same polymer or a related polymer by knowing the sequence of the original polymer. By changing (e.g., mutating) the sequence of the template, different monomer units may be introduced, thereby allowing the synthesis of related polymers, which can subsequently be selected and evolved. In certain preferred embodiments, several anti-codons may code for one monomer unit as is the case in Nature.

Additionally, the association between the anti-codon and the reactive unit, for example, a monomer unit, in the transfer unit may be covalent or non-covalent. The association maybe through a covalent bond and, in certain embodiments, the covalent bond may be severable.

Thus, the anti-codon can be associated with the reactant through a linker moiety. The linkage can be cleavable by light, oxidation, hydrolysis, exposure to acid, exposure to base, reduction, etc. Fruchtel et al. (1996) ANGEW. CHEM. INT. ED. ENGL. 35: 17 describes a variety of linkages useful in the practice of the invention. The linker facilitates contact of the reactant with the small molecule scaffold and in certain embodiments, depending on the desired reaction, positions DNA as a leaving group (“autocleavable” strategy), or may link reactive groups to the template via the “scarless” linker strategy (which yields product without leaving behind an additional atom or atoms having chemical functionality), or a “useful scar” strategy (in which a portion of the linker is left behind to be functionalized in subsequent steps following linker cleavage).

With the “autocleavable” linker strategy, the DNA-reactive group bond is cleaved as a natural consequence of the reaction. In the “scarless” linker strategy, DNA-templated reaction of one reactive group is followed by cleavage of the linker attached through a second reactive group to yield products without leaving behind additional atoms capable of providing chemical functionality. Alternatively, a “useful scar” may be utilized on the theory that it may be advantageous to introduce useful atoms and/or chemical groups as a consequence of linker cleavage. In particular, a “useful scar” is left behind following linker cleavage and can be functionalized in subsequent steps.

The anti-codon and the reactive unit (monomer unit) may also be associated through non-covalent interactions such as ionic, electrostatic, hydrogen bonding, van der Waals interactions, hydrophobic interactions, pi-stacking, etc. and combinations thereof. To give but one example, an anti-codon may be linked to biotin, and a monomer unit linked to streptavidin. The propensity of streptavidin to bind biotin leads to the non-covalent association between the anti-codon and the monomer unit to form the transfer unit.

The specific annealing of transfer units to templates permits the use of transfer units at concentrations lower than concentrations used in many traditional organic syntheses. Thus, transfer units can be used at submillimolar concentrations (e.g. less than 100 μm, less than 10 μM, less than 1 μM, less than 100 nM, or less than 10 nM).

### III. Chemical Reactions

A variety of compounds and/or libraries can be prepared using the methods described herein. In certain embodiments, compounds that are not, or do not resemble, nucleic acids or analogs thereof, are synthesized according to the method of the invention.

### (i) Coupling Reactions for Polymer Synthesis

In certain embodiments, polymers, specifically unnatural polymers, are prepared according to the method of the present invention. The unnatural polymers that can be created using the inventive method and system include any unnatural polymers. Exemplary unnatural polymers include, but are not limited to, peptide nucleic acid (PNA) polymers, polycarbamates, polyureas, polyesters, polyacrylate, polyalkylene (e.g., polyethylene, polypropylene), polycarbonates, polypeptides with unnatural stereochemistry, polypeptides with unnatural amino acids, and combination thereof. In certain embodiments, the polymers comprise at least 10, 25, 75, 100, 125, 150 monomer units or more. The polymers synthesized using the inventive system may be used, for example, as catalysts, pharmaceuticals, metal chelators, or catalysts.

In preparing certain unnatural polymers, the monomer units attached to the anti-codons may be any monomers or oligomers capable of being joined together to form a polymer. The monomer units may be, for example, carbamates, D-amino acids, unnatural amino acids, PNAs, ureas, hydroxy acids, esters, carbonates, acrylates, or ethers. In certain embodiments, the monomer units have two reactive groups used to link the monomer unit into the growing polymer chain, as depicted in FIG. 2. Preferably, the two reactive groups are not the same so that the monomer unit may be incorporated into the polymer in a directional sense, for example, at one end may be an electrophile and at the other end a nucleophile. Reactive groups may include, but are not limited to, esters, amides, carboxylic acids, activated carbonyl groups, acid chlorides, amines, hydroxyl groups, and thiols. In certain embodiments, the reactive groups are masked or protected (Greene et al. (1999) PROTECTIVE GROUPS IN ORGANIC SYNTHESIS 3rd Edition, Wiley) so that polymerization may not take place until a desired time when the reactive groups are deprotected. Once the monomer units are assembled along the nucleic acid template, initiation of the polymerization sequence results in a cascade of polymerization and deprotection steps wherein the polymerization step results in deprotection of a reactive group to be used in the subsequent polymerization step.

The monomer units to be polymerized can include two or more monomers depending on the geometry along the nucleic acid template. The monomer units to be polymerized must be able to stretch along the nucleic acid template and particularly across the distance spanned by its encoding anti-codon and optional spacer sequence. In certain embodiments, the monomer unit actually comprises two monomers, for example, a dicarbamate, a diurea, or a dipeptide. In yet other embodiments, the monomer unit comprises three or more monomers.

The monomer units may contain any chemical groups known in the art. Reactive chemical groups especially those that would interfere with polymerization, hybridization, etc., are preferably masked using known protecting groups (Greene et al. (1999) supra). In general, the protecting groups used to mask these reactive groups are orthogonal to those used in protecting the groups used in the polymerization steps.

It has been discovered that, under certain circumstances, the type of chemical reaction may affect the fidelity of the polymerization process. For example, distance independent chemical reactions (for example, reactions that occur efficiently when the reactive units are spaced apart by intervening bases, for example, amine acylation reactions) may result in the spurious incorporation of the wrong monomers at a particular position of a polymer chain. In contrast, by choosing chemical reactions for template mediated syntheses that are distance dependent (for example, reactions that become inefficient the further the reactive units are spaced part via intervening bases, for example, reductive amination reactions), it is possible control the fidelity of the polymerization process.

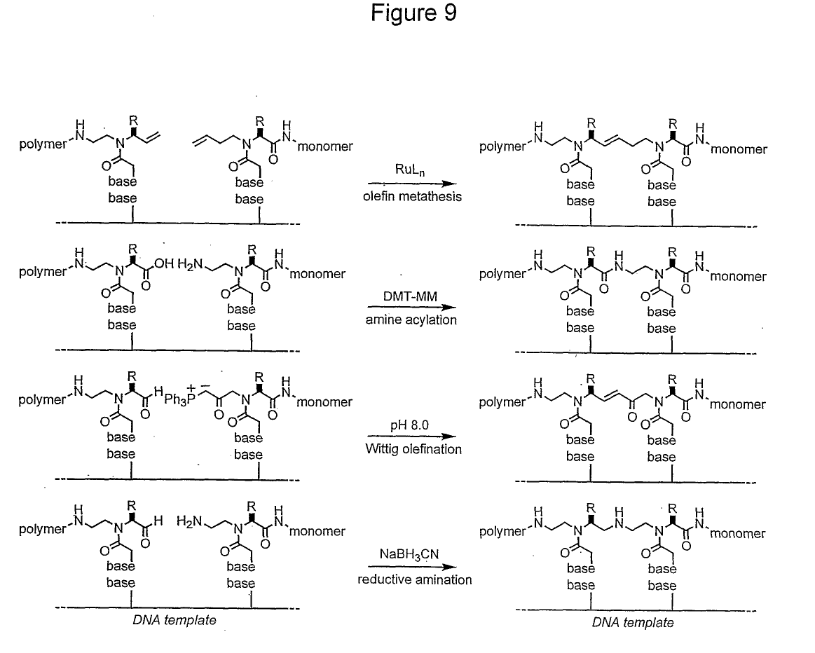

Exemplary coupling chemistries for DNA-templated polymerization reactions are presented in FIG. 9. Exemplary chemistries include, for example, olefin metathesis, amine acylations, wittig olefinations and reductive aminations.

### (iv) Reaction Conditions

Nucleic acid-templated reactions can occur in aqueous or non-aqueous (i.e., organic) solutions, or a mixture of one or more aqueous and non-aqueous solutions. In aqueous solutions, reactions can be performed at pH ranges from about 2 to about 12, or preferably from about 2 to about 10, or more preferably from about 4 to about 10. The reactions used in DNA-templated chemistry preferably should not require very basic conditions (e.g., pH>12, pH>10) or very acidic conditions (e.g., pH<1, pH<2, pH<4), because extreme conditions may lead to degradation or modification of the nucleic acid template and/or molecule (for example, the polymer, or small molecule) being synthesized. The aqueous solution can contain one or more inorganic salts, including, but not limited to, NaCl, Na₂SO₄, KCl, Mg⁺², Mn⁺², etc., at various concentrations.

Organic solvents suitable for nucleic acid-templated reactions include, but are not limited to, methylene chloride, chloroform, dimethylformamide, and organic alcohols, including methanol and ethanol. To permit quantitative dissolution of reaction components in organic solvents, quaternized ammonium salts, such as, for example, long chain tetraalkylammonium salts, can be added (Jost et al. (1989) NUCLEIC ACIDS RES. 17: 2143; Mel'nikov et al. (1999) LANGMUIR 15: 1923-1928).

Nucleic acid-templated reactions may require a catalyst, such as, for example, homogeneous, heterogeneous, phase transfer, and asymmetric catalysis. In other embodiments, a catalyst is not required. The presence of additional, accessory reagents not linked to a nucleic acid are preferred in some embodiments. Useful accessory reagents can include, for example, oxidizing agents (e.g., NaIO₄); reducing agents (e.g., NaCNBH₃); activating reagents (e.g., EDC, NHS, and sulfo-NHS); transition metals such as nickel (e.g., Ni(NO₃)₂), rhodium (e.g. RhCl₃), ruthenium (e.g. RuCl₃), copper (e.g. Cu(NO₃)₂), cobalt (e.g. CoCl₂), iron (e.g. Fe(NO₃)₃), osmium (e.g. OsO₄), titanium (e.g. TiCl₄ or titanium tetraisopropoxide), palladium (e.g. NaPdCl₄), or Ln; transition metal ligands (e.g., phosphines, amines, and halides); Lewis acids; and Lewis bases.

Reaction conditions preferably are optimized to suit the nature of the reactive units and oligonucleotides used.

### (v) Classes of Chemical Reactions

Known chemical reactions for synthesizing polymers can be used in nucleic acid-templated reactions. Thus, reactions such as those listed in March's Advanced Organic Chemistry, Organic Reactions, Organic Syntheses, organic text books, journals such as Journal of the American Chemical Society, Journal of Organic Chemistry, Tetrahedron, etc., and Carruther's Some Modern Methods of Organic Chemistry can be used. The chosen reactions preferably are compatible with nucleic acids such as DNA or RNA or are compatible with the modified nucleic acids used as the template.

Reactions useful in nucleic-acid templated chemistry include, for example, substitution reactions, carbon-carbon bond forming reactions, elimination reactions, acylation reactions, and addition reactions. An illustrative but not exhaustive list of aliphatic nucleophilic substitution reactions useful in the present invention includes, for example, S_{N}2 reactions, S_{N}1 reactions, S_{N}i reactions, allylic rearrangements, nucleophilic substitution at an aliphatic trigonal carbon, and nucleophilic substation at a vinylic carbon.

Specific aliphatic nucleophilic substitution reactions with oxygen nucleophiles include, for example, hydrolysis of alkyl halides, hydrolysis of gen-dihalides, hydrolysis of 1,1,1-trihalides, hydrolysis of alkyl esters or inorganic acids, hydrolysis of diazo ketones, hydrolysis of acetal and enol ethers, hydrolysis of epoxides, hydrolysis of acyl halides, hydrolysis of anhydrides, hydrolysis of carboxylic esters, hydrolysis of amides, alkylation with alkyl halides (Williamson Reaction), epoxide formation, alkylation with inorganic esters, alkylation with diazo compounds, dehydration of alcohols, transetherification, alcoholysis of epoxides, alkylation with onium salts, hydroxylation of silanes, alcoholysis of acyl halides, alcoholysis of anhydrides, esterfication of carboxylic acids, alcoholysis of carboxylic esters (transesterfication), alcoholysis of amides, alkylation of carboxylic acid salts, cleavage of ether with acetic anhydride, alkylation of carboxylic acids with diazo compounds, acylation of caroxylic acids with acyl halides, acylation of carboxylic acids with carboxylic acids, formation of oxonium salts, preparation of peroxides and hydroperoxides, preparation of inorganic esters (e.g., nitrites, nitrates, sulfonates), preparation of alcohols from amines, and preparation of mixed organic-inorganic anhydrides.

Specific aliphatic nucleophilic substitution reactions with sulfur nucleophiles, which tend to be better nucleophiles than their oxygen analogs, include, for example, attack by SH at an alkyl carbon to form thiols, attack by S at an alkyl carbon to form thioethers, attack by SH or SR at an acyl carbon, formation of disulfides, formation of Bunte salts, alkylation of sulfinic acid salts, and formation of alkyl thiocyanates.

Aliphatic nucleophilic substitution reactions with nitrogen nucleophiles include, for example, alkylation of amines, N-arylation of amines, replacement of a hydroxy by an amino group, transamination, transamidation, alkylation of amines with diazo compounds, amination of epoxides, amination of oxetanes, amination of aziridines, amination of alkanes, formation of isocyanides, acylation of amines by acyl halides, acylation of amines by anhydrides, acylation of amines by carboxylic acids, acylation of amines by carboxylic esters, acylation of amines by amides, acylation of amines by other acid derivatives, N-alkylation or N-arylation of amides and imides, N-acylation of amides and imides, formation of aziridines from epoxides, formation of nitro compounds, formation of azides, formation of isocyanates and isothiocyanates, and formation of azoxy compounds.

Aliphatic nucleophilic substitution reactions with halogen nucleophiles include, for example, attack at an alkyl carbon, halide exchange, formation of alkyl halides from esters of sulfuric and sulfonic acids, formation of alkyl halides from alcohols, formation of alkyl halides from ethers, formation of halohydrins from epoxides, cleavage of carboxylic esters with lithium iodide, conversion of diazo ketones to α-halo ketones, conversion of amines to halides, conversion of tertiary amines to cyanamides (the von Braun reaction), formation of acyl halides from carboxylic acids, and formation of acyl halides from acid derivatives.

Aliphatic nucleophilic substitution reactions using hydrogen as a nucleophile include, for example, reduction of alkyl halides, reduction of tosylates, other sulfonates, and similar compounds, hydrogenolysis of alcohols, hydrogenolysis of esters (Barton-McCombie reaction), hydrogenolysis of nitriles, replacement of alkoxyl by hydrogen, reduction of epoxides, reductive cleavage of carboxylic esters, reduction of a C—N bond, desulfurization, reduction of acyl halides, reduction of carboxylic acids, esters, and anhydrides to aldehydes, and reduction of amides to aldehydes.

Although certain carbon nucleophiles may be too nucleophilic and/or basic to be used in certain embodiments of the invention, aliphatic nucleophilic substitution reactions using carbon nucleophiles include, for example, coupling with silanes, coupling of alkyl halides (the Wurtz reaction), the reaction of alkyl halides and sulfonate esters with Group I (I A) and II (II A) organometallic reagents, reaction of alkyl halides and sulfonate esters with organocuprates, reaction of alkyl halides and sulfonate esters with other organometallic reagents, allylic and propargylic coupling with a halide substrate, coupling of organometallic reagents with esters of sulfuric and sulfonic acids, sulfoxides, and sulfones, coupling involving alcohols, coupling of organometallic reagents with carboxylic esters, coupling of organometallic reagents with compounds containing an esther linkage, reaction of organometallic reagents with epoxides, reaction of organometallics with aziridine, alkylation at a carbon bearing an active hydrogen, alkylation of ketones, nitriles, and carboxylic esters, alkylation of carboxylic acid salts, alkylation at a position α to a heteroatom (alkylation of 1,3-dithianes), alkylation of dihydro-1,3-oxazine (the Meyers synthesis of aldehydes, ketones, and carboxylic acids), alkylation with trialkylboranes, alkylation at an alkynyl carbon, preparation of nitriles, direct conversion of alkyl halides to aldehydes and ketones, conversion of alkyl halides, alcohols, or alkanes to carboxylic acids and their derivatives, the conversion of acyl halides to ketones with organometallic compounds, the conversion of anhydrides, carboxylic esters, or amides to ketones with organometallic compounds, the coupling of acyl halides, acylation at a carbon bearing an active hydrogen, acylation of carboxylic esters by carboxylic esters (the Claisen and Dieckmann condensation), acylation of ketones and nitriles with carboxylic esters, acylation of carboxylic acid salts, preparation of acyl cyanides, and preparation of diazo ketones, ketonic decarboxylation.

Reactions which involve nucleophilic attack at a sulfonyl sulfur atom may also be used in the present invention and include, for example, hydrolysis of sulfonic acid derivatives (attack by OH), formation of sulfonic esters (attack by OR), formation of sulfonamides (attack by nitrogen), formation of sulfonyl halides (attack by halides), reduction of sulfonyl chlorides (attack by hydrogen), and preparation of sulfones (attack by carbon).

Aromatic electrophilic substitution reactions may also be used in nucleotide-templated chemistry. Hydrogen exchange reactions are examples of aromatic electrophilic substitution reactions that use hydrogen as the electrophile. Aromatic electrophilic substitution reactions which use nitrogen electrophiles include, for example, nitration and nitro-de-hydrogenation, nitrosation of nitroso-de-hydrogenation, diazonium coupling, direct introduction of the diazonium group, and amination or amino-de-hydrogenation. Reactions of this type with sulfur electrophiles include, for example, sulfonation, sulfo-de-hydrogenation, halosulfonation, halosulfo-de-hydrogenation, sulfurization, and sulfonylation. Reactions using halogen electrophiles include, for example, halogenation, and halo-de-hydrogenation. Aromatic electrophilic substitution reactions with carbon electrophiles include, for example, Friedel-Crafts alkylation, alkylation, alkyl-de-hydrogenation, Friedel-Crafts arylation (the Scholl reaction), Friedel-Crafts acylation, formylation with disubstituted formamides, formylation with zinc cyanide and HCl (the Gatterman reaction), formylation with chloroform (the Reimer-Tiemann reaction), other formylations, formyl-de-hydrogenation, carboxylation with carbonyl halides, carboxylation with carbon dioxide (the Kolbe-Schmitt reaction), amidation with isocyanates, N-alkylcarbamoyl-de-hydrogenation, hydroxyalkylation, hydroxyalkyl-de-hydrogenation, cyclodehydration of aldehydes and ketones, haloalkylation, halo-de-hydrogenation, aminoalkylation, amidoalkylation, dialkylaminoalkylation, dialkylamino-de-hydrogenation, thioalkylation, acylation with nitriles (the Hoesch reaction), cyanation, and cyano-de-hydrogenation. Reactions using oxygen electrophiles include, for example, hydroxylation and hydroxy-de-hydrogenation.

Rearrangement reactions include, for example, the Fries rearrangement, migration of a nitro group, migration of a nitroso group (the Fischer-Hepp Rearrangement), migration of an arylazo group, migration of a halogen (the Orton rearrangement), migration of an alkyl group, etc. Other reaction on an aromatic ring include the reversal of a Friedel-Crafts alkylation, decarboxylation of aromatic aldehydes, decarboxylation of aromatic acids, the Jacobsen reaction, deoxygenation, desulfonation, hydro-de-sulfonation, dehalogenation, hydro-de-halogenation, and hydrolysis of organometallic compounds.

Aliphatic electrophilic substitution reactions are also useful. Reactions using the S_{E}1, S_{E}2 (front), S_{E}2 (back), S_{Ei}, addition-elimination, and cyclic mechanisms can be used in the present invention. Reactions of this type with hydrogen as the leaving group include, for example, hydrogen exchange (deuterio-de-hydrogenation, deuteriation), migration of a double bond, and keto-enol tautomerization. Reactions with halogen electrophiles include, for example, halogenation of aldehydes and ketones, halogenation of carboxylic acids and acyl halides, and halogenation of sulfoxides and sulfones. Reactions with nitrogen electrophiles include, for example, aliphatic diazonium coupling, nitrosation at a carbon bearing an active hydrogen, direct formation of diazo compounds, conversion of amides to α-azido amides, direct amination at an activated position, and insertion by nitrenes. Reactions with sulfur or selenium electrophiles include, for example, sulfenylation, sulfonation, and selenylation of ketones and carboxylic esters. Reactions with carbon electrophiles include, for example, acylation at an aliphatic carbon, conversion of aldehydes to β-keto esters or ketones, cyanation, cyano-de-hydrogenation, alkylation of alkanes, the Stork enamine reaction, and insertion by carbenes. Reactions with metal electrophiles include, for example, metalation with organometallic compounds, metalation with metals and strong bases, and conversion of enolates to silyl enol ethers. Aliphatic electrophilic substitution reactions with metals as leaving groups include, for example, replacement of metals by hydrogen, reactions between organometallic reagents and oxygen, reactions between organometallic reagents and peroxides, oxidation of trialkylboranes to borates, conversion of Grignard reagents to sulfur compounds, halo-de-metalation, the conversion of organometallic compounds to amines, the conversion of organometallic compounds to ketones, aldehydes, carboxylic esters and amides, cyano-de-metalation, transmetalation with a metal, transmetalation with a metal halide, transmetalation with an organometallic compound, reduction of alkyl halides, metallo-de-halogenation, replacement of a halogen by a metal from an organometallic compound, decarboxylation of aliphatic acids, cleavage of alkoxides, replacement of a carboxyl group by an acyl group, basic cleavage of β-keto esters and β-diketones, haloform reaction, cleavage of non-enolizable ketones, the Haller-Bauer reaction, cleavage of alkanes, decyanation, and hydro-de-cyanation. Electrophlic substitution reactions at nitrogen include, for example, diazotization, conversion of hydrazines to azides, N-nitrosation, N-nitroso-de-hydrogenation, conversion of amines to azo compounds, N-halogenation, N-halo-de-hydrogenation, reactions of amines with carbon monoxide, and reactions of amines with carbon dioxide.

Aromatic nucleophilic substitution reactions may also be used in the present invention. Reactions proceeding via the S_{N}Ar mechanism, the S_{N}1 mechanism, the benzyne mechanism, the S_{RN}1 mechanism, or other mechanism, for example, can be used. Aromatic nucleophilic substitution reactions with oxygen nucleophiles include, for example, hydroxy-de-halogenation, alkali fusion of sulfonate salts, and replacement of OR or OAr. Reactions with sulfur nucleophiles include, for example, replacement by SH or SR. Reactions using nitrogen nucleophiles include, for example, replacement by NH₂, NHR, or NR₂, and replacement of a hydroxy group by an amino group. Reactions with halogen nucleophiles include, for example, the introduction halogens. Aromatic nucleophilic substitution reactions with hydrogen as the nucleophile include, for example, reduction of phenols and phenolic esters and ethers, and reduction of halides and nitro compounds. Reactions with carbon nucleophiles include, for example, the Rosenmund-von Braun reaction, coupling of organometallic compounds with aryl halides, ethers, and carboxylic esters, arylation at a carbon containing an active hydrogen, conversions of aryl substrates to carboxylic acids, their derivatives, aldehydes, and ketones, and the Ullmann reaction. Reactions with hydrogen as the leaving group include, for example, alkylation, arylation, and amination of nitrogen heterocycles. Reactions with N₂⁺ as the leaving group include, for example, hydroxy-de-diazoniation, replacement by sulfur-containing groups, iodo-de-diazoniation, and the Schiemann reaction. Rearrangement reactions include, for example, the von Richter rearrangement, the Sommelet-Hauser rearrangement, rearrangement of aryl hydroxylamines, and the Smiles rearrangement.

Reactions involving free radicals can also be used, although the free radical reactions used in nucleotide-templated chemistry should be carefully chosen to avoid modification or cleavage of the nucleotide template. With that limitation, free radical substitution reactions can be used in the present invention. Particular free radical substitution reactions include, for example, substitution by halogen, halogenation at an alkyl carbon, allylic halogenation, benzylic halogenation, halogenation of aldehydes, hydroxylation at an aliphatic carbon, hydroxylation at an aromatic carbon, oxidation of aldehydes to carboxylic acids, formation of cyclic ethers, formation of hydroperoxides, formation of peroxides, acyloxylation, acyloxy-de-hydrogenation, chlorosulfonation, nitration of alkanes, direct conversion of aldehydes to amides, amidation and amination at an alkyl carbon, simple coupling at a susceptible position, coupling of alkynes, arylation of aromatic compounds by diazonium salts, arylation of activated alkenes by diazonium salts (the Meerwein arylation), arylation and alkylation of alkenes by organopalladium compounds (the Heck reaction), arylation and alkylation of alkenes by vinyltin compounds (the Stille reaction), alkylation and arylation of aromatic compounds by peroxides, photochemical arylation of aromatic compounds, alkylation, acylation, and carbalkoxylation of nitrogen heterocycles Particular reactions in which N₂⁺ is the leaving group include, for example, replacement of the diazonium group by hydrogen, replacement of the diazonium group by chlorine or bromine, nitro-de-diazoniation, replacement of the diazonium group by sulfur-containing groups, aryl dimerization with diazonium salts, methylation of diazonium salts, vinylation of diazonium salts, arylation of diazonium salts, and conversion of diazonium salts to aldehydes, ketones, or carboxylic acids. Free radical substitution reactions with metals as leaving groups include, for example, coupling of Grignard reagents, coupling of boranes, and coupling of other organometallic reagents. Reaction with halogen as the leaving group are included. Other free radical substitution reactions with various leaving groups include, for example, desulfurization with Raney Nickel, conversion of sulfides to organolithium compounds, decarboxylative dimerization (the Kolbe reaction), the Hunsdiecker reaction, decarboxylative allylation, and decarbonylation of aldehydes and acyl halides.

Reactions involving additions to carbon-carbon multiple bonds are also used in nucleotide-templated chemistry. Any mechanism may be used in the addition reaction including, for example, electrophilic addition, nucleophilic addition, free radical addition, and cyclic mechanisms. Reactions involving additions to conjugated systems can also be used. Addition to cyclopropane rings can also be utilized. Particular reactions include, for example, isomerization, addition of hydrogen halides, hydration of double bonds, hydration of triple bonds, addition of alcohols, addition of carboxylic acids, addition of H₂S and thiols, addition of ammonia and amines, addition of amides, addition of hydrazoic acid, hydrogenation of double and triple bonds, other reduction of double and triple bonds, reduction of the double and triple bonds of conjugated systems, hydrogenation of aromatic rings, reductive cleavage of cyclopropanes, hydroboration, other hydrometalations, addition of alkanes, addition of alkenes and/or alkynes to alkenes and/or alkynes (e.g., pi-cation cyclization reactions, hydro-alkenyl-addition), ene reactions, the Michael reaction, addition of organometallics to double and triple bonds not conjugated to carbonyls, the addition of two alkyl groups to an alkyne, 1,4-addition of organometallic compounds to activated double bonds, addition of boranes to activated double bonds, addition of tin and mercury hydrides to activated double bonds, acylation of activated double bonds and of triple bonds, addition of alcohols, amines, carboxylic esters, aldehydes, etc., carbonylation of double and triple bonds, hydrocarboxylation, hydroformylation, addition of aldehydes, addition of HCN, addition of silanes, radical addition, radical cyclization, halogenation of double and triple bonds (addition of halogen, halogen), halolactonization, halolactamization, addition of hypohalous acids and hypohalites (addition of halogen, oxygen), addition of sulfur compounds (addition of halogen, sulfur), addition of halogen and an amino group (addition of halogen, nitrogen), addition of NOX and NO₂X (addition of halogen, nitrogen), addition of XN₃ (addition of halogen, nitrogen), addition of alkyl halides (addition of halogen, carbon), addition of acyl halides (addition of halogen, carbon), hydroxylation (addition of oxygen, oxygen) (e.g., asymmetric dihydroxylation reaction with OsO₄), dihydroxylation of aromatic rings, epoxidation (addition of oxygen, oxygen) (e.g., Sharpless asymmetric epoxidation), photooxidation of dienes (addition of oxygen, oxygen), hydroxysulfenylation (addition of oxygen, sulfur), oxyamination (addition of oxygen, nitrogen), diamination (addition of nitrogen, nitrogen), formation of aziridines (addition of nitrogen), aminosulfenylation (addition of nitrogen, sulfur), acylacyloxylation and acylamidation (addition of oxygen, carbon or nitrogen, carbon), 1,3-dipolar addition (addition of oxygen, nitrogen, carbon), Diels-Alder reaction, heteroatom Diels-Alder reaction, all carbon 3+2 cycloadditions, dimerization of alkenes, the addition of carbenes and carbenoids to double and triple bonds, trimerization and tetramerization of alkynes, and other cycloaddition reactions.

In addition to reactions involving additions to carbon-carbon multiple bonds, addition reactions to carbon-hetero multiple bonds can be used in nucleotide-templated chemistry. Exemplary reactions include, for example, the addition of water to aldehydes and ketones (formation of hydrates), hydrolysis of carbon-nitrogen double bond, hydrolysis of aliphatic nitro compounds, hydrolysis of nitriles, addition of alcohols and thiols to aldehydes and ketones, reductive alkylation of alcohols, addition of alcohols to isocyanates, alcoholysis of nitriles, formation of xanthates, addition of H₂S and thiols to carbonyl compounds, formation of bisulfite addition products, addition of amines to aldehydes and ketones, addition of amides to aldehydes, reductive alkylation of ammonia or amines, the Mannich reaction, the addition of amines to isocyanates, addition of ammonia or amines to nitrites, addition of amines to carbon disulfide and carbon dioxide, addition of hydrazine derivative to carbonyl compounds, formation of oximes, conversion of aldehydes to nitrites, formation of gem-dihalides from aldehydes and ketones, reduction of aldehydes and ketones to alcohols, reduction of the carbon-nitrogen double bond, reduction of nitrites to amines, reduction of nitrites to aldehydes, addition of Grignard reagents and organolithium reagents to aldehydes and ketones, addition of other organometallics to aldehydes and ketones, addition of trialkylallylsilanes to aldehydes and ketones, addition of conjugated alkenes to aldehydes (the Baylis-Hillman reaction), the Reformatsky reaction, the conversion of carboxylic acid salts to ketones with organometallic compounds, the addition of Grignard reagents to acid derivatives, the addition of organometallic compounds to CO₂ and CS₂, addition of organometallic compounds to C═N compounds, addition of carbenes and diazoalkanes to C═N compounds, addition of Grignard reagents to nitrites and isocyanates, the Aldol reaction, Mukaiyama Aldol and related reactions, Aldol-type reactions between carboxylic esters or amides and aldehydes or ketones, the Knoevenagel reaction (e.g., the Nef reaction, the Favorskii reaction), the Peterson alkenylation reaction, the addition of active hydrogen compounds to CO₂ and CS₂, the Perkin reaction, Darzens glycidic ester condensation, the Tollens' reaction, the Wittig reaction, the Tebbe alkenylation, the Petasis alkenylation, alternative alkenylations, the Thorpe reaction, the Thorpe-Ziegler reaction, addition of silanes, formation of cyanohydrins, addition of HCN to C═N and C═N bonds, the Prins reaction, the benzoin condensation, addition of radicals to C═O, C═S, C═N compounds, the Ritter reaction, acylation of aldehydes and ketones, addition of aldehydes to aldehydes, the addition of isocyanates to isocyanates (formation of carbodiimides), the conversion of carboxylic acid salts to nitrites, the formation of epoxides from aldehydes and ketones, the formation of episulfides and episulfones, the formation of β-lactones and oxetanes (e.g., the Paterno-Büchi reaction), the formation of β-lactams, etc. Reactions involving addition to isocyanides include the addition of water to isocyanides, the Passerini reaction, the Ug reaction, and the formation of metalated aldimines.

Elimination reactions, including α, β, and γ eliminations, as well as extrusion reactions, can be performed using nucleotide-templated chemistry, although the strength of the reagents and conditions employed should be considered. Preferred elimination reactions include reactions that go by E1, E2, E1cB, or E2C mechanisms. Exemplary reactions include, for example, reactions in which hydrogen is removed from one side (e.g., dehydration of alcohols, cleavage of ethers to alkenes, the Chugaev reaction, ester decomposition, cleavage of quarternary ammonium hydroxides, cleavage of quaternary ammonium salts with strong bases, cleavage of amine oxides, pyrolysis of keto-ylids, decomposition of toluene-p-solfonylhydrazones, cleavage of sulfoxides, cleavage of selenoxides, cleavage of sulformes, dehydrogalogenation of alkyl halides, dehydrohalogenation of acyl halides, dehydrohalogenation of sulfonyl halides, elimination of boranes, conversion of alkenes to alkynes, decarbonylation of acyl halides), reactions in which neither leaving atom is hydrogen (e.g., deoxygenation of vicinal diols, cleavage of cyclic thionocarbonates, conversion of epoxides to episulfides and alkenes, the Ramberg-Bäcklund reaction, conversion of aziridines to alkenes, dehalogenation of vicinal dihalides, dehalogenation of α-halo acyl halides, and elimination of a halogen and a hetero group), fragmentation reactions (i.e., reactions in which carbon is the positive leaving group or the electrofuge, such as, for example, fragmentation of γ-amino and γ-hydroxy halides, fragmentation of 1,3-diols, decarboxylation of β-hydroxy carboxylic acids, decarboxylation of α-lactones, fragmentation of α,β-epoxy hydrazones, elimination of CO from briged bicyclic compounds, and elimination of CO₂ from bridged bicyclic compounds), reactions in which C≡N or C═N bonds are formed (e.g., dehydration of aldoximes or similar compounds, conversion of ketoximes to nitriles, dehydration of unsubstituted amides, and conversion of N-alkylformamides to isocyanides), reactions in which C═O bonds are formed (e.g., pyrolysis of β-hydroxy alkenes), and reactions in which N═N bonds are formed (e.g., eliminations to give diazoalkenes). Extrusion reactions include, for example, extrusion of N₂ from pyrazolines, extrusion of N₂ from pyrazoles, extrusion of N₂ from triazolines, extrusion of CO, extrusion of CO₂, extrusion of SO₂, the Story synthesis, and alkene synthesis by twofold extrusion.

Rearrangements, including, for example, nucleophilic rearrangements, electrophilic rearrangements, prototropic rearrangements, and free-radical rearrangements, can also be performed using nucleotide-templated chemistry. Both 1,2 rearrangements and non-1,2 rearrangements can be performed. Exemplary reactions include, for example, carbon-to-carbon migrations of R, H, and Ar (e.g., Wagner-Meerwein and related reactions, the Pinacol rearrangement, ring expansion reactions, ring contraction reactions, acid-catalyzed rearrangements of aldehydes and ketones, the dienone-phenol rearrangement, the Favorskii rearrangement, the Arndt-Eistert synthesis, homologation of aldehydes, and homologation of ketones), carbon-to-carbon migrations of other groups (e.g., migrations of halogen, hydroxyl, amino, etc.; migration of boron; and the Neber rearrangement), carbon-to-nitrogen migrations of R and Ar (e.g., the Hofmann rearrangement, the Curtius rearrangement, the Lossen rearrangement, the Schmidt reaction, the Beckman rearrangement, the Stieglits rearrangement, and related rearrangements), carbon-to-oxygen migrations of R and Ar (e.g., the Baeyer-Villiger rearrangement and rearrangement of hydroperoxides), nitrogen-to-carbon, oxygen-to-carbon, and sulfur-to-carbon migration (e.g., the Stevens rearrangement, and the Wittig rearrangement), boron-to-carbon migrations (e.g., conversion of boranes to alcohols (primary or otherwise), conversion of boranes to aldehydes, conversion of boranes to carboxylic acids, conversion of vinylic boranes to alkenes, formation of alkynes from boranes and acetylides, formation of alkenes from boranes and acetylides, and formation of ketones from boranes and acetylides), electrocyclic rearrangements (e.g., of cyclobutenes and 1,3-cyclohexadienes, or conversion of stilbenes to phenanthrenes), sigmatropic rearrangements (e.g., (1,j) sigmatropic migrations of hydrogen, (1,j) sigmatropic migrations of carbon, conversion of vinylcyclopropanes to cyclopentenes, the Cope rearrangement, the Claisen rearrangement, the Fischer indole synthesis, (2,3) sigmatropic rearrangements, and the benzidine rearrangement), other cyclic rearrangements (e.g., metathesis of alkenes, the di-π-methane and related rearrangements, and the Hofmann-Löffler and related reactions), and non-cyclic rearrangements (e.g., hydride shifts, the Chapman rearrangement, the Wallach rearrangement, and dyotropic rearrangements).

Oxidative and reductive reactions may also be performed using nucleotide-templated chemistry. Exemplary reactions may involve, for example, direct electron transfer, hydride transfer, hydrogen-atom transfer, formation of ester intermediates, displacement mechanisms, or addition-elimination mechanisms. Exemplary oxidations include, for example, eliminations of hydrogen (e.g., aromatization of six-membered rings, dehydrogenations yielding carbon-carbon double bonds, oxidation or dehydrogenation of alcohols to aldehydes and ketones, oxidation of phenols and aromatic amines to quinones, oxidative cleavage of ketones, oxidative cleavage of aldehydes, oxidative cleavage of alcohols, ozonolysis, oxidative cleavage of double bonds and aromatic rings, oxidation of aromatic side chains, oxidative decarboxylation, and bisdecarboxylation), reactions involving replacement of hydrogen by oxygen (e.g., oxidation of methylene to carbonyl, oxidation of methylene to OH, CO₂R, or OR, oxidation of arylmethanes, oxidation of ethers to carboxylic esters and related reactions, oxidation of aromatic hydrocarbons to quinones, oxidation of amines or nitro compounds to aldehydes, ketones, or dihalides, oxidation of primary alcohols to carboxylic acids or carboxylic esters, oxidation of alkenes to aldehydes or ketones, oxidation of amines to nitroso compounds and hydroxylamines, oxidation of primary amines, oximes, azides, isocyanates, or notroso compounds, to nitro compounds, oxidation of thiols and other sulfur compounds to sulfonic acids), reactions in which oxygen is added to the subtrate (e.g., oxidation of alkynes to α-diketones, oxidation of tertiary amines to amine oxides, oxidation of thioesters to sulfoxides and sulfones, and oxidation of carboxylic acids to peroxy acids), and oxidative coupling reactions (e.g., coupling involving carbanoins, dimerization of silyl enol ethers or of lithium enolates, and oxidation of thiols to disulfides).

Exemplary reductive reactions include, for example, reactions involving replacement of oxygen by hydrogen (e.g., reduction of carbonyl to methylene in aldehydes and ketones, reduction of carboxylic acids to alcohols, reduction of amides to amines, reduction of carboxylic esters to ethers, reduction of cyclic anhydrides to lactones and acid derivatives to alcohols, reduction of carboxylic esters to alcohols, reduction of carboxylic acids and esters to alkanes, complete reduction of epoxides, reduction of nitro compounds to amines, reduction of nitro compounds to hydroxylamines, reduction of nitroso compounds and hydroxylamines to amines, reduction of oximes to primary amines or aziridines, reduction of azides to primary amines, reduction of nitrogen compounds, and reduction of sulfonyl halides and sulfonic acids to thiols), removal of oxygen from the substrate (e.g., reduction of amine oxides and azoxy compounds, reduction of sulfoxides and sulfones, reduction of hydroperoxides and peroxides, and reduction of aliphatic nitro compounds to oximes or nitriles), reductions that include cleavage (e.g., de-alkylation of amines and amides, reduction of azo, azoxy, and hydrazo compounds to amines, and reduction of disulfides to thiols), reductive couplic reactions (e.g., bimolecular reduction of aldehydes and ketones to 1,2-diols, bimolecular reduction of aldehydes or ketones to alkenes, acyloin ester condensation, reduction of nitro to azoxy compounds, and reduction of nitro to azo compounds), and reductions in which an organic substrate is both oxidized and reduced (e.g., the Cannizzaro reaction, the Tishchenko reaction, the Pummerer rearrangement, and the Willgerodt reaction).

### IV. Selection and Screening

Selection and/or screening for reaction products with desired activities (such as catalytic activity, binding affinity, or a particular effect in an activity assay) may be performed using methodologies known and used in the art. For example, affinity selections may be performed according to the principles used in library-based selection methods such as phage display, polysome display, and mRNA-fusion protein displayed peptides. Selection for catalytic activity may be performed by affinity selections on transition-state analog affinity columns (Baca et al. (1997) PROC. NATL. ACAD. SCI. USA 94(19): 10063-8) or by function-based selection schemes (Pedersen et al. (1998) PROC. NATL. ACAD. SCI. USA 95(18): 10523-8). Since minute quantities of DNA (˜10⁻²⁰ mol) can be amplified by PCR (Kramer et al (1999) CURRENT PROTOCOLS IN MOLECULAR BIOLOGY (ed. Ausubel, F. M.) 15.1-15.3, Wiley), these selections can be conducted on a scale ten or more orders of magnitude less than that required for reaction analysis by current methods, making a truly broad search both economical and efficient.

### (i) Selection for Binding to Target Molecule

The templates and reaction products can be selected (or screened) for binding to a target molecule. In this context, selection or partitioning means any process whereby a library member bound to a target molecule is separated from library members not bound to target molecules. Selection can be accomplished by various methods known in the art.

The templates of the present invention contain a built-in function for direct selection and amplification. In most applications, binding to a target molecule preferably is selective, such that the template and the resulting reaction product bind preferentially with a specific target molecule, perhaps preventing or inducing a specific biological effect. Ultimately, a binding molecule identified using the present invention may be useful as a therapeutic and/or diagnostic agent. Once the selection is complete, the selected templates optionally can be amplified and sequenced. The selected reaction products, if present in sufficient quantity, can be separated from the templates, purified (e.g., by HPLC, column chromatography, or other chromatographic method), and further characterized.

### (ii) Target Molecules

Binding assays provide a rapid means for isolating and identifying reaction products that bind to, for example, a surface (such as metal, plastic, composite, glass, ceramics, rubber, skin, or tissue); a polymer; a catalyst; or a target biomolecule such as a nucleic acid, a protein (including enzymes, receptors, antibodies, and glycoproteins), a signal molecule (such as cAMP, inositol triphosphate, peptides, or prostaglandins), a carbohydrate, or a lipid. Binding assays can be advantageously combined with activity assays for the effect of a reaction product on a function of a target molecule.

The selection strategy can be carried out to allow selection against almost any target. Importantly, the selection strategy does not require any detailed structural information about the target molecule or about the molecules in the libraries. The entire process is driven by the binding affinity involved in the specific recognition and binding of the molecules in the library to a given target. Examples of various selection procedures are described below.

The libraries of the present invention can contain molecules that could potentially bind to any known or unknown target. The binding region of a target molecule could include a catalytic site of an enzyme, a binding pocket on a receptor (for example, a G-protein coupled receptor), a protein surface area involved in a protein-protein or protein-nucleic acid interaction (preferably a hot-spot region), or a specific site on DNA (such as the major groove). The natural function of the target could be stimulated (agonized), reduced (antagonized), unaffected, or completely changed by the binding of the reaction product. This will depend on the precise binding mode and the particular binding site the reaction product occupies on the target.

Functional sites (such as protein-protein interaction or catalytic sites) on proteins often are more prone to bind molecules than are other more neutral surface areas on a protein. In addition, these functional sites normally contain a smaller region that seems to be primarily responsible for the binding energy: the so-called “hot-spot regions” (Wells, et al. (1993) RECENT PROG. HORMONE RES. 48: 253-262). This phenomenon facilitates selection for molecules affecting the biological function of a certain target.

The linkage between the template molecule and reaction product allows rapid identification of binding molecules using various selection strategies. This invention broadly permits identifying binding molecules for any known target molecule. In addition, novel unknown targets can be discovered by isolating binding molecules against unknown antigens (epitopes) and using these binding molecules for identification and validation. In another preferred embodiment, the target molecule is designed to mimic a transition state of a chemical reaction; one or more reaction products resulting from the selection may stabilize the transition state and catalyze the chemical reaction.

(iii) Binding Assays

The template-directed synthesis of the invention permits selection procedures analogous to other display methods such as phage display (Smith (1985) SCIENCE 228: 1315-1317). Phage display selection has been used successfully on peptides (Wells et al. (1992) CURR. OP. STRUCT. BIOL. 2: 597-604), proteins (Marks et al. (1992) J. BIOL. CHEM. 267: 16007-16010) and antibodies (Winter et al. (1994) ANNU. REV. IMMUNOL. 12: 433-455). Similar selection procedures also are exploited for other types of display systems such as ribosome display Mattheakis et al. (1994) PROC. NATL. ACAD. SCI. 91: 9022-9026) and mRNA display (Roberts, et al. (1997) PROC. NATL. ACAD. SCI. 94:12297-302). The libraries of the present invention, however, allow direct selection of target-specific molecules without requiring traditional ribosome-mediated translation. The present invention also allows the display of small molecules which have not previously been synthesized directly from a nucleic acid template.

Selection of binding molecules from a library can be performed in any format to identify optimal binding molecules. Binding selections typically involve immobilizing the desired target molecule, adding a library of potential binders, and removing non-binders by washing. When the molecules showing low affinity for an immobilized target are washed away, the molecules with a stronger affinity generally remain attached to the target. The enriched population remaining bound to the target after stringent washing is preferably eluted with, for example, acid, chaotropic salts, heat, competitive elution with a known ligand or by proteolytic release of the target and/or of template molecules. The eluted templates are suitable for PCR, leading to many orders of amplification, whereby essentially each selected template becomes available at a greatly increased copy number for cloning, sequencing, and/or further enrichment or diversification.

In a binding assay, when the concentration of ligand is much less than that of the target (as it would be during the selection of a DNA-templated library), the fraction of ligand bound to target is determined by the effective concentration of the target protein. The fraction of ligand bound to target is a sigmoidal function of the concentration of target, with the midpoint (50% bound) at [target]=K_{d} of the ligand-target complex. This relationship indicates that the stringency of a specific selection—the minimum ligand affinity required to remain bound to the target during the selection—is determined by the target concentration. Therefore, selection stringency is controllable by varying the effective concentration of target.

The target molecule (peptide, protein, DNA or other antigen) can be immobilized on a solid support, for example, a container wall, a wall of a microtiter plate well. The library preferably is dissolved in aqueous binding buffer in one pot and equilibrated in the presence of immobilized target molecule. Non-binders are washed away with buffer. Those molecules that may be binding to the target molecule through their attached DNA templates rather than through their synthetic moieties can be eliminated by washing the bound library with unfunctionalized templates lacking PCR primer binding sites. Remaining bound library members then can be eluted, for example, by denaturation.

Alternatively, the target molecule can be immobilized on beads, particularly if there is doubt that the target molecule will adsorb sufficiently to a container wall, as may be the case for an unfolded target eluted from an SDS-PAGE gel. The derivatized beads can then be used to separate high-affinity library members from nonbinders by simply sedimenting the beads in a benchtop centrifuge. Alternatively, the beads can be used to make an affinity column. In such cases, the library is passed through the column one or more times to permit binding. The column then is washed to remove nonbinding library members. Magnetic beads are essentially a variant on the above; the target is attached to magnetic beads which are then used in the selection.

There are many reactive matrices available for immobilizing the target molecule, including matrices bearing —NH₂ groups or —SH groups. The target molecule can be immobilized by conjugation with NHS ester or maleimide groups covalently linked to Sepharose beads and the integrity of known properties of the target molecule can be verified. Activated beads are available with attachment sites for —NH₂ or —COOH groups (which can be used for coupling). Alternatively, the target molecule is blotted onto nitrocellulose or PVDF. When using a blotting strategy, the blot should be blocked (e.g., with BSA or similar protein) after immobilization of the target to prevent nonspecific binding of library members to the blot.

Library members that bind a target molecule can be released by denaturation, acid, or chaotropic salts. Alternatively, elution conditions can be more specific to reduce background or to select for a desired specificity. Elution can be accomplished using proteolysis to cleave a linker between the target molecule and the immobilizing surface or between the reaction product and the template. Also, elution can be accomplished by competition with a known competitive ligand for the target molecule. Alternatively, a PCR reaction can be performed directly in the presence of the washed target molecules at the end of the selection procedure. Thus, the binding molecules need not be elutable from the target to be selectable since only the template is needed for further amplification or cloning, not the reaction product itself. Indeed, some target molecules bind the most avid ligands so tightly that elution would be difficult.

To select for a molecule that binds a protein expressible on a cell surface, such as an ion channel or a transmembrane receptor, the cells themselves can be used as the selection agent. The library preferably is first exposed to cells not expressing the target molecule on their surfaces to remove library members that bind specifically or non specifically to other cell surface epitopes. Alternatively, cells lacking the target molecule are present in large excess in the selection process and separable (by fluorescence-activated cell sorting (FACS), for example) from cells bearing the target molecule. In either method, cells bearing the target molecule then are used to isolate library members bearing the target molecule (e.g., by sedimenting the cells or by FACS sorting). For example, a recombinant DNA encoding the target molecule can be introduced into a cell line; library members that bind the transformed cells but not the untransformed cells are enriched for target molecule binders. This approach is also called subtraction selection and has successfully been used for phage display on antibody libraries (Hoogenboom et al. (1998) IMMUNOTECH 4: 1-20).

A selection procedure can also involve selection for binding to cell surface receptors that are internalized so that the receptor together with the selected binding molecule passes into the cytoplasm, nucleus, or other cellular compartment, such as the Golgi or lysosomes. Depending on the dissociation rate constant for specific selected binding molecules, these molecules may localize primarily within the intracellular compartments. Internalized library members can be distinguished from molecules attached to the cell surface by washing the cells, preferably with a denaturant. More preferably, standard subcellular fractionation techniques are used to isolate the selected library members in a desired subcellular compartment.

An alternative selection protocol also includes a known, weak ligand affixed to each member of the library. The known ligand guides the selection by interacting with a defined part of the target molecule and focuses the selection on molecules that bind to the same region, providing a cooperative effect. This can be particularly useful for increasing the affinity of a ligand with a desired biological function but with too low a potency.

Other methods for selection or partitioning are also available for use with the present invention. These include, for example: immunoprecipitation (direct or indirect) where the target molecule is captured together with library members; mobility shift assays in agarose or polyacrylamide gels, where the selected library members migrate with the target molecule in a gel; cesium chloride gradient centrifugation to isolate the target molecule with library members; mass spectroscopy to identify target molecules labeled with library members. In general, any method where the library member/target molecule complex can be separated from library members not bound to the target is useful.

The selection process is well suited for optimizations, where the selection steps are made in series, starting with the selection of binding molecules and ending with an optimized binding molecule. The procedures in each step can be automated using various robotic systems. Thus, the invention permits supplying a suitable library and target molecule to a fully automatic system which finally generates an optimized binding molecule. Under ideal conditions, this process should run without any requirement for external work outside the robotic system during the entire procedure.

The selection methods of the present invention can be combined with secondary selection or screening to identify reaction products capable of modifying target molecule function upon binding. Thus, the methods described herein can be employed to isolate or produce binding molecules that bind to and modify the function of any protein or nucleic acid. For example, nucleic acid-templated chemistry can be used to identify, isolate, or produce binding molecules (1) affecting catalytic activity of target enzymes by inhibiting catalysis or modifying substrate binding; (2) affecting the functionality of protein receptors, by inhibiting binding to receptors or by modifying the specificity of binding to receptors; (3) affecting the formation of protein multimers by disrupting the quaternary structure of protein subunits; or (4) modifying transport properties of a protein by disrupting transport of small molecules or ions.

Functional assays can be included in the selection process. For example, after selecting for binding activity, selected library members can be directly tested for a desired functional effect, such as an effect on cell signaling. This can, for example, be performed via FACS methodologies.

The binding molecules of the invention can be selected for other properties in addition to binding. For example, to select for stability of binding interactions in a desired working environment. If stability in the presence of a certain protease is desired, that protease can be part of the buffer medium used during selection. Similarly, the selection can be performed in serum or cell extracts or in any type of medium, aqueous or organic. Conditions that disrupt or degrade the template should however be avoided to allow subsequent amplification.

### (iv) Other Selections

Selections for other desired properties, such as catalytic or other functional activities, can also be performed. Generally, the selection should be designed such that library members with the desired activity are isolatable on that basis from other library members. For example, library members can be screened for the ability to fold or otherwise significantly change conformation in the presence of a target molecule, such as a metal ion, or under particular pH or salinity conditions. The folded library members can be isolated by performing non-denaturing gel electrophoresis under the conditions of interest. The folded library members migrate to a different position in the gel and can subsequently be extracted from the gel and isolated.

Similarly, reaction products that fluoresce in the presence of specific ligands may be selected by FACS based sorting of translated polymers linked through their DNA templates to beads. Those beads that fluoresce in the presence, but not in the absence, of the target ligand are isolated and characterized. Useful beads with a homogenous population of nucleic acid-templates on any bead can be prepared using the split-pool synthesis technique on the bead, such that each bead is exposed to only a single nucleotide sequence. Alternatively, a different anti-template (each complementary to only a single, different template) can by synthesized on beads using a split-pool technique, and then can anneal to capture a solution-phase library.

Biotin-terminated biopolymers can be selected for the actual catalysis of bond-breaking reactions by passing these biopolymers over a resin linked through a substrate to avidin. Those biopolymers that catalyze substrate cleavage self-elute from a column charged with this resin. Similarly, biotin-terminated biopolymers can be selected for the catalysis of bond-forming reactions. One substrate is linked to resin and the second substrate is linked to avidin. Biopolymers that catalyze bond formation between the substrates are selected by their ability to react the substrates together, resulting in attachment of the biopolymer to the resin.

Library members can also be selected for their catalytic effects on synthesis of a polymer to which the template is or becomes attached. For example, the library member may influence the selection of monomer units to be polymerized as well as how the polymerization reaction takes place (e.g., stereochemistry, tacticity, activity). The synthesized polymers can be selected for specific properties, such as, molecular weight, density, hydrophobicity, tacticity, stereoselectivity, using standard techniques, such as, electrophoresis, gel filtration, centrifugal sedimentation, or partitioning into solvents of different hydrophobicities. The attached template that directed the synthesis of the polymer can then be identified.

Library members that catalyze virtually any reaction causing bond formation between two substrate molecules or resulting in bond breakage into two product molecules can be selected using the schemes proposed herein. To select for bond forming catalysts (for example, hetero Diels-Alder, Heck coupling, aldol reaction, or olefin metathesis catalysts), library members are covalently linked to one substrate through their 5′ amino or thiol termini. The other substrate of the reaction is synthesized as a derivative linked to biotin. When dilute solutions of library-substrate conjugate are combined with the substrate-biotin conjugate, those library members that catalyze bond formation cause the biotin group to become covalently attached to themselves. Active bond forming catalysts can then be separated from inactive library members by capturing the former with immobilized streptavidin and washing away inactive library members

In an analogous manner, library members that catalyze bond cleavage reactions such as retro-aldol reactions, amide hydrolysis, elimination reactions, or olefin dihydroxylation followed by periodate cleavage can be selected. In this case, library members are covalently linked to biotinylated substrates such that the bond breakage reaction causes the disconnection of the biotin moiety from the library members. Upon incubation under reaction conditions, active catalysts, but not inactive library members, induce the loss of their biotin groups. Streptavidin-linked beads can then be used to capture inactive polymers, while active catalysts are able to be eluted from the beads. Related bond formation and bond cleavage selections have been used successfully in catalytic RNA and DNA evolution (Jäschke et al. (2000) CURR. OPIN. CHEM. BIOL. 4: 257-62) Although these selections do not explicitly select for multiple turnover catalysis, RNAs and DNAs selected in this manner have in general proven to be multiple turnover catalysts when separated from their substrate moieties (Jaschke et al. (2000) CURR. OPIN. CHEM. BIOL. 4: 257-62; Jaeger et al. (1999) PROC. NATL. ACAD. SCI. USA 96: 14712-7; Bartel et al. (1993) SCIENCE 261: 1411-8; Sen et al. (1998) CURR. OPIN. CHEM. BIOL. 2: 680-7).

In addition to simply evolving active catalysts, the in vitro selections described above are used to evolve non-natural polymer libraries in powerful directions difficult to achieve using other catalyst discovery approaches. Substrate specificity among catalysts can be selected by selecting for active catalysts in the presence of the desired substrate and then selecting for inactive catalysts in the presence of one or more undesired substrates. If the desired and undesired substrates differ by their configuration at one or more stereocenters, enantioselective or diastereoselective catalysts can emerge from rounds of selection. Similarly, metal selectivity can be evolved by selecting for active catalysts in the presence of desired metals and selecting for inactive catalysts in the presence of undesired metals. Conversely, catalysts with broad substrate tolerance can be evolved by varying substrate structures between successive rounds of selection.

Importantly, in vitro selections can also select for specificity in addition to binding affinity. Library screening methods for binding specificity typically require duplicating the entire screen for each target or non-target of interest. In contrast, selections for specificity can be performed in a single experiment by selecting for target binding as well as for the inability to bind one or more non-targets. Thus, the library can be pre-depleted by removing library members that bind to a non-target. Alternatively, or in addition, selection for binding to the target molecule can be performed in the presence of an excess of one or more non-targets. To maximize specificity, the non-target can be a homologous molecule. If the target molecule is a protein, appropriate non-target proteins include, for example, a generally promiscuous protein such as an albumin. If the binding assay is designed to target only a specific portion of a target molecule, the non-target can be a variation on the molecule in which that portion has been changed or removed.

### (vi) Amplification and Sequencing

Once all rounds of selection are complete, the templates which are, or formerly were, associated with the selected reaction product preferably are amplified using any suitable technique to facilitate sequencing or other subsequent manipulation of the templates. Natural oligonucleotides can be amplified by any state of the art method. These methods include, for example, polymerase chain reaction (PCR); nucleic acid sequence-based amplification (see, for example, Compton (1991) NATURE 350: 91-92), amplified anti-sense RNA (see, for example, van Gelder et al. (1988) PROC. NATL. ACAD. SCI. USA 85: 77652-77656); self-sustained sequence replication systems (Gnatelli et al. (1990) PROC. NATL. ACAD. SCI. USA 87: 1874-1878); polymerase-independent amplification (see, for example, Schmidt et al. (1997) NUCLEIC ACIDS RES. 25: 4797-4802, and in vivo amplification of plasmids carrying cloned DNA fragments. Descriptions of PCR methods are found, for example, in Saiki et al. (1985) SCIENCE 230: 1350-1354; Scharf et al. (1986) SCIENCE 233: 1076-1078; and in U.S. Pat. No. 4,683,202. Ligase-mediated amplification methods such as Ligase Chain Reaction (LCR) may also be used. In general, any means allowing faithful, efficient amplification of selected nucleic acid sequences can be employed in the method of the present invention. It is preferable, although not necessary, that the proportionate representations of the sequences after amplification reflect the relative proportions of sequences in the mixture before amplification.

For non-natural nucleotides the choices of efficient amplification procedures are fewer. As non-natural nucleotides can be incorporated by certain enzymes including polymerases it will be possible to perform manual polymerase chain reaction by adding the polymerase during each extension cycle.

For oligonucleotides containing nucleotide analogs, fewer methods for amplification exist. One may use non-enzyme mediated amplification schemes (Schmidt et al. (1997) NUCLEIC ACIDS RES. 25: 4797-4802). For backbone-modified oligonucleotides such as PNA and LNA, this amplification method may be used. Alternatively, standard PCR can be used to amplify a DNA from a PNA or LNA oligonucleotide template. Before or during amplification the templates or complementing templates may be mutagenized or recombined in order to create an evolved library for the next round of selection or screening.

(vii) Sequence Determination and Template Evolution

Sequencing can be done by a standard dideoxy chain termination method, or by chemical sequencing, for example, using the Maxam-Gilbert sequencing procedure. Alternatively, the sequence of the template (or, if a long template is used, the variable portion(s) thereof) can be determined by hybridization to a chip. For example, a single-stranded template molecule associated with a detectable moiety such as a fluorescent moiety is exposed to a chip bearing a large number of clonal populations of single-stranded nucleic acids or nucleic acid analogs of known sequence, each clonal population being present at a particular addressable location on the chip. The template sequences are permitted to anneal to the chip sequences. The position of the detectable moieties on the chip then is determined. Based upon the location of the detectable moiety and the immobilized sequence at that location, the sequence of the template can be determined. It is contemplated that large numbers of such oligonucleotides can be immobilized in an array on a chip or other solid support.

Libraries can be evolved by introducing mutations at the DNA level, for example, using error-prone PCR (Cadwell et al. (1992) PCR METHODS APPLIC. 2: 28) or by subjecting the DNA to in vitro homologous recombination (Stemmer (1994) PROC. NATL. ACAD. SCI. USA 91: 10747; Stemmer (1994) NATURE 370: 389) or by cassette mutagenesis.

### (a) Error-Prone PCR

Random point mutagenesis is performed by conducting the PCR amplification step under error-prone PCR (Cadwell et al. (1992) PCR METHODS APPLIC. 2: 28-33) conditions. Because the genetic code of these molecules are written to assign related codons to related chemical groups, similar to the way that the natural protein genetic code is constructed, random point mutations in the templates encoding selected molecules will diversify progeny towards chemically related analogs. Because error-prone PCR is inherently less efficient than normal PCR, error-prone PCR diversification is preferably conducted with only natural dATP, dTTP, dCTP, and dGTP and using primers that lack chemical handles or biotin groups.

### (b) Recombination

Libraries may be diversified using recombination. For example, templates to be recombined may have a structure in which codons are separated by five-base non-palindromic restriction endonuclease cleavage sites such as those cleaved by AvaII (G/GWCC, W=A or T), Sau96I (G/GNCC, N=A, G, T, or C), DdeI (C/TNAG), or HinFI (G/ANTC). Following selections, templates encoding desired molecules are enzymatically digested with these commercially available restriction enzymes. The digested fragments then are recombined into intact templates with T4 DNA ligase. Because the restriction sites separating codons are nonpalindromic, template fragments can only reassemble to form intact recombined templates (FIG. 14). DNA-templated translation of recombined templates provides recombined small molecules. In this way, functional groups between synthetic small molecules with desired activities are recombined in a manner analogous to the recombination of amino acid residues between proteins in Nature. It is well appreciated that recombination explores the sequence space of a molecule much more efficiently than point mutagenesis alone (Minshull et al. (1999) CURR. OPIN. CHEM. BIOL. 3: 284-90; Bogarad et al. (1999) PROC. NATL. ACAD. SCI. USA 96: 2591-5; Stemmer NATURE 370: 389-391).

A preferred method of diversifying library members is through non homologous random recombination, as described, for example, in WO 02/074978; US Patent Application Publication No. 2003-0027180-A1; and Bittker et al. (2002) NATURE BIOTECH. 20(10): 1024-9.

### (c) Random Cassette Mutagenesis

Random cassette mutagenesis is useful to create a diversified library from a fixed starting sequence. Thus, such a method can be used, for example, after a library has been subjected to selection and one or more library members have been isolated and sequenced. Generally, a library of oligonucleotides with variations on the starting sequence is generated by traditional chemical synthesis, error-prone PCR, or other methods. For example, a library of oligonucleotides can be generated in which, for each nucleotide position in a codon, the nucleotide has a 90% probability of being identical to the starting sequence at that position, and a 10% probability of being different. The oligonucleotides can be complete templates when synthesized, or can be fragments that are subsequently ligated with other oligonucleotides to form a diverse library of templates.

Information about template design, codon usage, transfer unit design, coupling chemistries, reaction conditions, and selection and screening protocols can be found, for example, in U.S. Patent Publication Nos. US-2003/0113738 and US-2004/0180412.

### V. Uses

The methods and compositions of the present invention represent new ways to generate polymers with desired properties. This approach marries extremely powerful genetic methods, which molecular biologists have taken advantage of for decades, with the flexibility and power of organic chemistry. The ability to prepare, amplify, and evolve unnatural polymers by genetic selection may lead to new classes of catalysts that possess activity, bioavailability, stability, fluorescence, photolability, or other properties that are difficult or impossible to achieve using the limited set of building blocks found in proteins and nucleic acids.

For example, unnatural biopolymers useful as artificial receptors to selectively bind molecules or as catalysts for chemical reactions can be isolated. Characterization of these molecules would provide important insight into the ability of polycarbamates, polyureas, polyesters, polycarbonates, polypeptides with unnatural side chain and stereochemistries, or other unnatural polymers to form secondary or tertiary structures with binding or catalytic properties.

### EXAMPLES

### Example 1

### Polymer Evolution by Templated Synthesis

A proposed scheme for synthetic polymer evolution using DNA-templated organic synthesis is shown in FIG. 2. Peptide nucleic acid (PNA) is an attractive candidate for this strategy because PNA monomers are readily synthesized in the laboratory and because their ability to associate sequence-specifically with nucleic acids enables PNA coupling to be controlled by nucleic acid-templated synthesis (Nielsen, P. E. (1997) BIOPHYS. CHEM. 68, 103-8; Schmidt et al. (1997) NUCLEIC ACIDS RES. 25, 4797-802; Schmidt et al. (1997) NUCLEIC ACIDS RES. 25, 4792-6; Bohler et al. (1995) NATURE 376, 578-81). Previous studies have established the ability of DNA-templated reductive amination reactions (Li, X et al. (2002) J. AM. CHEM. SOC. 124, 746-7; Li, X. et al. (2002) ANGEW CHEM. INT. ED. ENGL. 41, 4567-9; Rosenbaum & Liu (2003) J. AM. CHEM. SOC. 125, 13924-5; Gothelf et al. (2004) J. AM. CHEM. SOC. 126, 1044-6) to mediate the polymerization of PNA aldehyde oligomers on DNA hairpin templates (Rosenbaum et al. (2003) J. AM. CHEM. SOC. 125, 13924-5). Although these reactions exhibited promising degrees of efficiency and sequence-specificity when applied to single DNA template sequences containing predominantly AGTC codons (Li et al. (2002) J. AM. CHEM. SOC. 124, 746-7; Li, X. & Lynn, D. G. (2002) ANGEW CHEM. INT. ED. ENGL. 41, 4567-9), they have not previously been applied to the more complex problems of translating highly varied templates or translating libraries containing many different templates simultaneously.

Using DNA-templated polymerization and a frameshift-resistant “genetic code”, a library of 3.5×10⁹ DNA sequences was translated into a corresponding library of peptide nucleic acid 40-mers, each of which was covalently linked to its DNA template. In vitro selection for binding to a target protein followed by PCR amplification of surviving templates led to the identification of a PNA with confirmed protein binding activity and specificity. The DNA encoding this PNA was partially randomized, re-translated, and re-selected to yield a second-generation synthetic polymer with improved target protein affinity. The results demonstrate that non-enzymatic, template-directed synthesis can support the evolution-driven discovery of functional synthetic polymers that would be difficult to isolate using conventional synthesis and screening methods. In addition, these results establish the ability of PNAs to adopt conformations capable of binding specifically to target proteins.

### 1. Materials and Methods

### (a) DNA Template Preparation.

DNA templates were synthesized on a PerSeptive Biosystems Expedite 8090 DNA synthesizer using standard phosphoramidite protocols. All DNA synthesis reagents were purchased from Glen Research. DNA templates for polymerization experiments were synthesized with a 5′-MMT-amino-dT phosphoramidite at the 5′ terminus (abbreviated H₂NT in the sequences below). Purification of DNA templates was carried out by (i) deprotection with 1:1 ammonium hydroxide:methylamine for 60 min at 55° C.; (ii) reverse-phase HPLC purification of the MMT-containing fraction using a [8% acetonitrile in 0.1 M TEAA pH 7] to [40% acetonitrile in 0.1 M TEAA pH 7] solvent gradient with a column temperature of 45° C.; (iii) MMT cleavage with 80% acetic acid for 60 min; (iv) reverse-phase HPLC purification of the MMT-deprotected product. In addition, templates for library translation were subjected to PAGE purification on a 10% denaturing polyacrylamide gel.

Template sequences are as follows:

(ATTC)₁₀ coding region

(SEQ ID NO: 1)

H₂NTGCGACGGTATACCGTCGCAATTCATTCATTCATTCATTCATTCATT
CATTCATTCATTC
(AGTC)₁₀ coding region

(SEQ ID NO: 2)

H₂NTGCGACGGTATACCGTCGCAAGTCAGTCAGTCAGTGAGTCAGTCAGT
CAGTCAGTCAGTC
(ACTC)₁₀ coding region

(SEQ ID NO: 3)

H₂NTGCGACGGTATACCGTCGCAACTCACTCACTCACTCACTCACTCACT
CACTCACTCACTC
(ACTCATGC)₅ coding region

(SEQ ID NO: 4)

H₂NTGCGACGGTATACCGTCGCAACTCATGCACTCATGCAGTCATGCACT
CATGCACTCATGC
(ACTCAGGC)₅ coding region

(SEQ ID NO: 5)

H₂NTGCGACGGTATACCGTCGCAACTCAGGCACTCAGGCACTCAGGCACT
CAGGCACTCAGGC
(ACGC)₁₀ coding region

(SEQ ID NO: 6)

H₂NTGCGACGGTATACCGTCGCAACGCACGCACGCACGCACGCACGCACG
CACGCACGCACGC
(ATCC)₁₀ coding region

(SEQ ID NO: 7)

H₂NTGCGACGGTATACCGTCGCAATCCATCCATCCATCCATCCATCCATC
CATCCATCCATCC
(AGCC)₁₀ coding region

(SEQ ID NO: 8)

H₂NTGCGACGGTATACCGTCGCAAGCCAGCCAGCCAGCCAGCCAGCCAGC
CAGCCAGCCAGCC
(ACCC)₁₀ coding region

(SEQ ID NO: 9)

H₂NTGCGACGGTATACCGTCGCAACCCACCCACCCACCCACCCACCCACC
CACCCACCCACCC
First-generation library

(SEQ ID NO: 10)

H₂NTGCGACGGTGCGCACCGTCGCAABBCABBCABBCABBCABBCABBCA
BBCABBCABBCABBCGGACAAGGTGCGCACCTTGTCC
Second-generation library

(SEQ ID NO: 11)

H₂NTGCGACGGTGCGCACCGTCGCAAGCCATTCATGCATBCABBCABBCA
TGCATTCATTCATGCGGACAAGGTGCGCACCTTGTCC

### (b) PNA Building Block Preparation.

PNA aldehyde building blocks were synthesized as reported previously (Li (2002) supra). Masses of the synthesized building blocks were verified by ESI mass spectrometry, and expected and observed masses of the building blocks are set forth in Table 2:

TABLE 2

| Sequence | Expected mass | Observed mass |
|---|---|---|
| gaat | 1109 | 1109.4 |
| gagt | 1125 | 1125.4 |
| ggat | 1125 | 1125.4 |
| gggt | 1141 | 1141.4 |
| ggct | 1101 | 1101.4 |
| gcat | 1085 | 1085.4 |
| gcgt | 1101 | 1101.4 |
| gact | 1085 | 1085.4 |
| gcct | 1061 | 1061.4 |

### (c) DNA-Templated Polymerization.

For the reactions presented in FIG. 3A, 20 μmol template DNA (containing 200 μmol total of four-base codons) was mixed with 800 μmol (4.0 equiv) PNA peptide aldehyde in 50 μL of 100 mM TAPS pH 8.5 buffer containing 1 M NaCl. The gcat and gcct building blocks were tested in hetero-polymerization reactions due to the tendency of their homo-polymerization templates to adopt internal secondary structure (gcat) or exhibit unusually low PNA-DNA melting temperature (Giesen, U. et al. (1998) Nucleic Acids Res. 26, 5004-5006) (gcct). Reactions were heated to 95° C. for 10 min and cooled to 25° C. over 1 hour. NaCNBH₃ was added to 80 mM. Reactions were allowed to proceed 1 hour at 25° C., then subjected to gel filtration twice (Princeton Separation). Products were analyzed by 10% denaturing PAGE. The same conditions were used for library polymerizations presented in FIG. 3B, except that 20 μmol library DNA template was used together with an equimolar mixture of nine gvvt PNA aldehyde building blocks (total peptide=800 mol, 1600 mol, or 3200 mol as specified below).

### (d) Displacement of the PNA Strand.

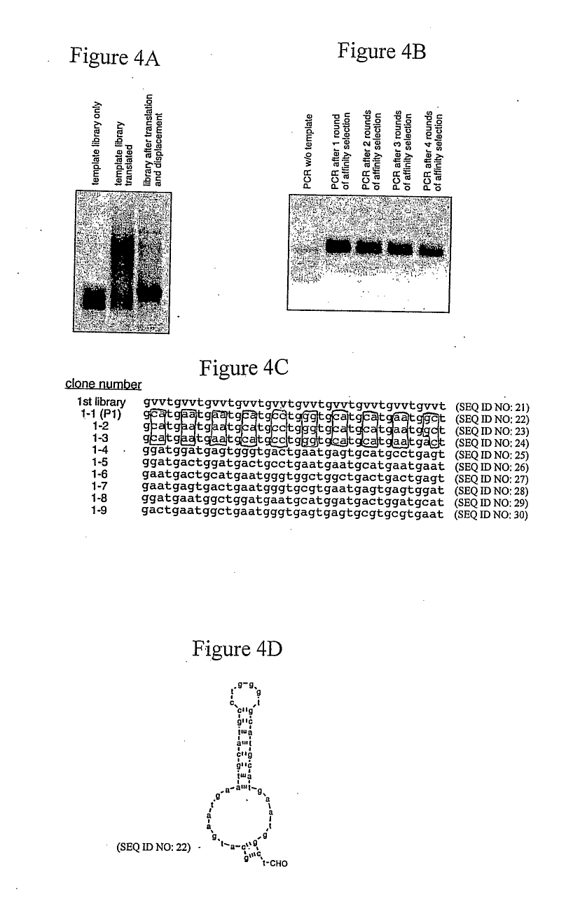

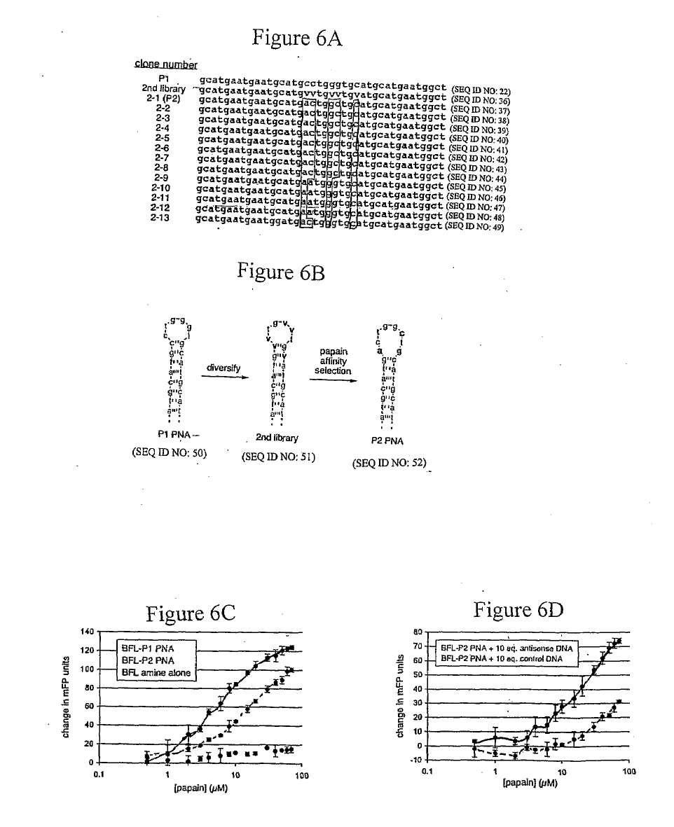

For the library material used in the selections presented in FIGS. 4 and 6, library polymerization was carried out using the protocol described above but with 3200 mol (16.0 equiv) PNA gvvt per 50 μL reaction. After gel filtration, one-half of the translation reaction (˜10 mol of product) was resuspended in 25 μL Thermopol buffer (New England Biolabs), 0.25 μL 25 mM dNTPs, and 0.5 μL (1 U) Therminator DNA polymerase (NEB). The displacement mixture was heated to 95° C. for 5 min, cooled to 55° C. for 45 s, and incubated at 72° C. for 30 min. After cooling to 25° C., the reaction was passed through a gel filtration column to remove buffer and dNTPs.

The PNA displacement of an individual translated double-hairpin template was typically analyzed as follows. The sequence of the template used in this experiment is shown below and contains a unique Sph I cleavage site (GCATGC, underlined) at nucleotides 35-40:

(SEQ ID NO: 12)

H₂NTCGAATTCGTACGAATTCGAAGTCACTCATCCATGCATGCACTCATC
CAGTCTTTTGTGCGGACGATCGTCCGCAC

The restriction endonuclease Sph I exclusively cleaves double-stranded DNA containing GCATGC. Therefore Sph I cleavage indicates the creation of double-stranded DNA in the template. We assume that double-stranded DNA is mutually exclusive with a PNA-DNA paired complex, and therefore Sph I cleavage also implies displacement of the PNA strand. The individual template was translated using the PNA aldehyde building blocks gact, gagt, ggat, and goat (20 mol template+160 mol each building block per 50 μL reaction). The translated template was displaced as described above.

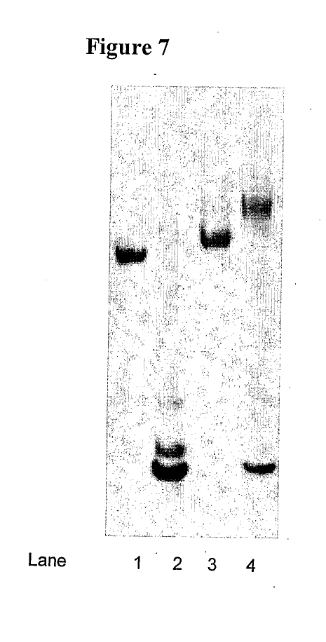

As an Sph I cleavage positive control, the untranslated double-hairpin template was also “filled in” using DNA polymerase. To create the positive control, 20 mol of untranslated template was combined with 250 μM dNTPs and 1 unit Klenow (exo-) DNA polymerase in 25 μL total Ecopol buffer. The reaction was incubated at 37° C. for 30 min, heated at 75° C. for 20 min (to heat-inactivate the DNA polymerase), and subjected to gel filtration. An aliquot (20 mol) of each sample (template alone, “filled in” control template, translated product, displaced product) was digested in 25 μL reactions containing NEB2 buffer (New England Biolabs) plus 5 U Sph I for 90 min at 37° C. Following digestion, samples were subjected to gel filtration, centrifuged under vacuum to dryness, resuspended in 50% formamide in 1×TBE, heated to 95° C. for 15 minutes, and analyzed by electrophoresis on a 10% denaturing (TBE-urea) PAGE gel followed by staining with ethidium bromide. The resulting gel is shown in FIG. 7, in which lane 1=template plus Sph I; lane 2=“filled in” template plus Sph I; lane 3=translation product plus Sph I; lane 4=translated and displacement product plus Sph I. The presence of the fast-running band in both lane 2 and lane 4 represents cleaved double-stranded DNA in both the positive control (lane 2) and in the translated and displaced product (lane 4).

### (e) Protein Affinity Selections.

The methods used for in vitro papain affinity selection have been reported previously (Giesen (1998) NUCLEIC ACIDS RES. 26, 5004-5006). Papain-conjugated sepharose beads (50 μL) were prepared according to this protocol and combined with 10 μmol of translated and displaced PNA library. After 4 hours at 4° C. with slow mixing, the beads were filtered, washed three times with high salt buffer (50 mM Tris pH 7.5, 0.5 M NaCl), once with low salt buffer (50 mM Tris pH 7.5, 0.1 M NaCl), and resuspended in 50 μL papain selection buffer (50 mM Tris pH 7.5, 100 mM NaCl, 1 mM EDTA). One fifth of the beads were removed for PCR as described below.

The remaining beads (40 μL) were heated for 15 min at 95° C., cooled to 60° C., supplemented with an equal volume of fresh papain-linked sepharose beads; cooled rapidly to 4° C., and the selection was repeated. This protocol was repeated three times (four rounds total) for the first-generation selection (FIG. 4A) and was repeated twice (three rounds total) for the second-generation selection (FIG. 6A). After each round of affinity selection, PCR was performed using one fifth of the total beads. Filtered beads were resuspended in 18 μL NEB buffer 4 with BSA, 1 μL Hha I, and 1 μL HinPI I (all restriction endonucleases purchased from New England Biolabs). Reactions were incubated for 1.5 hours at 37° C., then added directly into 80 μL PCR master mix containing 5 μL Taq buffer, 5 μL 25 mM MgCl₂, 1 μL 100 μM primer 1, 1 μL 100 μM primer 2, 1 μL 25 mM dNTPs, and 1 μL Taq DNA polymerase and 54 μL H₂O. Primer sequences are as follows:

| | |
|---|---|
| Primer 1 | |
| CCGCCGGGATCCGCACCGTCGCA | (SEQ ID NO: 13) |
| Primer 2 | |
| CCGCCGCTCGAGGCACCTTGTCC | (SEQ ID NO: 14) |

The PCR protocol was as follows: 25 cycles of 30 seconds at 94° C., 30 seconds at 55° C., and 30 seconds at 72° C. Selection PCR reactions were always performed side-by-side with a control reaction in which 20 μL water was used in the place of selection beads. In FIG. 4B, 10 μL of each PCR reaction was analyzed by 2.5% agarose gel electrophoresis.

### (f) Cloning and Analysis of Sequences Surviving Selection.

The 86-base pair PCR product resulting from the final round of selection (fourth round for first-generation library; third round from second-generation library) was purified by agarose gel electrophoresis, digested with BamH I and Xho I restriction endonucleases, and ligated into pBluescript II (Stratagene) digested with BamH I and Xho I. The ligation was transformed into 40 μL electrocompetent DH10B cells (Invitrogen) by electroporation. Individual colonies were cultured and their plasmids were sequenced using standard automated fluorescence-based DNA sequencing methods with the following primer:

| | |
|---|---|
| CACACAGGAAACAGCTATGACCATG | (SEQ ID NO: 15) |

Alignments of the resulting sequences were performed using the ClustalW algorithm (Zuker, M. Mfold web server for nucleic acid folding and hybridization prediction. NUCLEIC ACIDS RES. 31, 3406-15 (2003)).

### (g) Enrichment Assays.

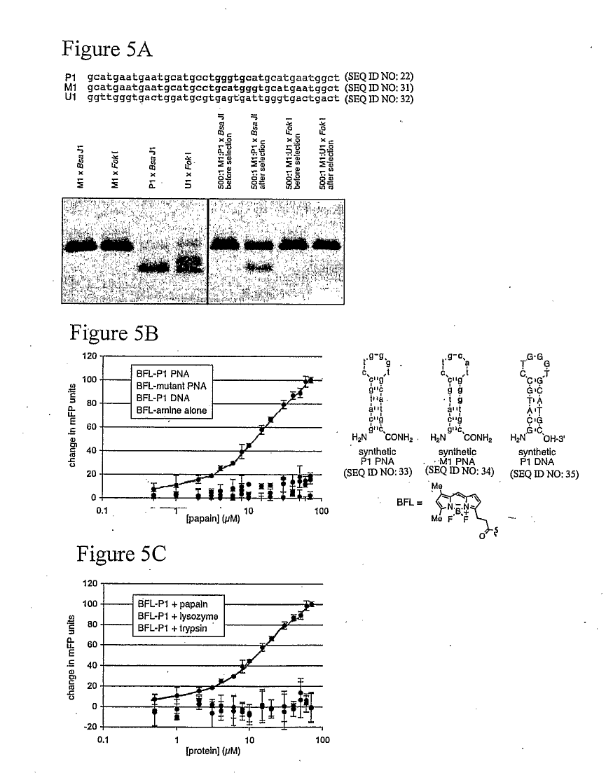

For the enrichment experiments described in FIG. 5A, 10 μmol total template:mixture (500:1 M1 template:P1 template; or 500:1 U1 template:P1 template) was translated as described above using library translation conditions. The individual template sequences are as follows:

P1 template

(SEQ ID NO: 16)

H₂NTGCGACGGTGCGCACCGTCGCAAGCCATTCATGCATGCACCCAGGCA
TGCATTCATTCATGCGGACAAGGTGCGCACCTTGTCC
M1 template

(SEQ ID NO: 17)

H₂NTGCGACGGTGCGCACCGTCGCAAGCCATTCATGCACCCATGCAGGCA
TGCATTCATTCATGCGGACAAGGTGCGCACCTTGTCC
U1 template

(SEQ ID NO: 18)

H₂NTGCGACGGTGCGCACCGTCGCAAGTCAGTCACCCAATCACTCACGCA
TCCAGTCACCCAACCGGACAAGGTGCGCACCTTGTCC

The translated products were displaced as described above, subjected to three rounds of selection against papain as described above, and the resulting bound DNA templates were digested and amplified by PCR as described above. The PCR product resulting from the M1/P1 experiment was digested with the restriction endonuclease BsaJI for 4 hours at 60° C., and compared to digests of PCR products from M1 template or P1 template alone. The PCR product resulting from the U1/P1 enrichment experiment was digested with Fok I for 4 hours at 37° C. and compared to digests of PCR products from U1 or P1 template alone.

### (h) Solid-Phase PNA Synthesis.

The solid-phase syntheses of selected PNA sequences (truncated P1, truncated P2, and truncated M1) were executed according to established protocols (Reader et al. (2002) NATURE 420, 841-4). Briefly, 50 mg FMOC-PAL-PEG-PS resin (Applied Biosystems) with a loading level of 0.17 mmol/g was swelled in DMF, and the FMOC group was removed with two washes of 5 mL 20% piperidine. All manipulations were performed at 25° C. in a peptide synthesis vessel with N₂ gas bubbled through the reaction mixtures. Each cycle of peptide synthesis consisted of: (i) coupling with an activated FMOC-protected monomer for 15 min, followed by washing with DMF; (ii) capping with 5% acetic anhydride in DMF for 5 min, followed by washing with DMF; and (iii) deprotection of the FMOC group with two washes of 5 mL 20% piperidine for 5 min, followed by washing with DMF. Monomers were activated by combining 50 μmol FMOC-PNA monomer (26-36 mg, depending on the monomer), 50 μmol HATU (19 mg), 100 μmol DIPEA (17.4 μL), and 50 μmol 2,6-lutidine (5.8 μL) in 1.2 mL DMF, and incubating the resulting reaction 7 min at 25° C.

After all peptide synthesis cycles were complete, the PNA was cleaved from solid support by resuspending the resin in a solution consisting of TFA+10% m-cresol+3% H₂O and bubbling with N₂ for 1 hour. The solution was filtered and PNAs were precipitated from the filtrate by adding 50 mL ice-cold t-butyl methyl ether (TBME) to the cleavage cocktail, after which a white precipitate immediately formed. The precipitate was isolated by centrifugation, and the pellet was washed several times with additional TBME. After lyophilization, the crude cleavage mixture was subjected to reverse-phase HPLC with a gradient from 0% to 35% acetonitrile in 0.1% aqueous TFA over 30 min (flow rate=4 mL/min). Peaks (monitoring absorbance at 260 nm) corresponding to PNA peptides were collected from 16 min to 22 min elution times, and each eluted peak was analyzed by MALDI mass spectrometry (sinapinic acid matrix) on an Applied Biosystems Voyager mass spectrometer. The peak corresponding to intact 18-base PNA peptide was consistently the last peak to elute from the column with absorption at 260 nm. The masses of the 18-base PNAs are as follows:

### P1: Expected=4929.5; Observed=4929.7

### M1: Expected=4929.5; Observed=4929.0

### P2: Expected=4913.5; Observed=4913.4

### (i) Papain Binding Assays.

Purified PNA 18-mers prepared as described above were reacted with BODIPY-fluorescein succinamidyl ester (BFL-SE, Molecular Probes). For each labelling reaction, 25 μL of a 250-400 μM stock solution of PNA in H₂O was mixed with 25 μL 0.2 M sodium bicarbonate (pH 8.0) plus 2.5 μL of a 20 mg/mL solution of BFL-SE in DMSO. After four hours at 25° C., 50 μL DMSO was added, and the labelling reaction was incubated for an additional 4 hours. The labelled product was purified by reverse-phase HPLC as described above. The addition of the BFL fluorophore on the N-terminal primary amine typically delayed the elution time of the PNA by ˜5 min, and the absorption of the eluted peak was monitored both at 260 nm and at 470 nm. Masses of labelled peptides were confirmed by MALDI mass spectrometry, as follows:

P1 labelled: Expected=5317.7; Observed=5317.1
M1 labelled: Expected=5317.7; Observed=5316.9
P2 labelled: Expected=5301.7; Observed=5302.2

Fluorescence polarization-based papain affinity assays were carried out as follows. BFL-labelled PNA was used at concentrations between 5 nM and 10 nM. This concentration range routinely provided signal:noise ratios exceeding 20:1. For the BFL-amine controls in FIGS. 5B and 6C, BFL-ethylenediamine (Molecular Probes) was used at a concentration of 10 nM. For each labelled PNA or control, a series of binding reactions were established containing papain selection buffer (see above), the labelled PNA or control, and one of several concentrations of papain. Papain (Sigma-Aldrich) was dissolved in papain activation buffer (5.5 mM cysteine HCl, 1.1 mM EDTA, and 0.067 mM β-mercaptoethanol) at 5 mg/mL. The protein was precisely diluted (in activation buffer) to a concentration of 100 μM. This stock solution was then used for all binding assays. After the binding reactions were equilibrated (4 hours at 25° C.), they were loaded onto a Nunc opaque black 384-well plate, and fluorescence polarization was measured using the Analyst AD system (Molecular Devices) with a fluorescein filter. Fluorescence polarization data in FIGS. 5B and 6C is shown as the change in fluorescence polarization (calculated relative to the output in the absence of protein) as a function of papain concentration. For the protein-binding specificity experiment shown in FIG. 5C, the same protocol was used, except that papain was replaced with trypsin or lysozyme, and protein was simply dissolved in papain selection buffer (rather than in activation buffer).

The papain binding assays of the truncated P2 PNA in the presence of DNA complementary to P2 were carried out as above, except that before the assays took place, a 500 nM solution of BFL-labelled truncated P2 PNA was combined with 5 μM (10 equiv) of “anti-P2” DNA or with “anti-control” DNA in papain selection buffer:

Anti-P2:

(SEQ ID NO: 19)

GCATGCAGCCAGTCATGC (complementary to P2)
Anti-control:

(SEQ ID NO: 20)

GCAGTCATGCATGCAGCC (scrambled codon control)

The solution was heated to 95° C. for 2 min, slowly cooled to 25° C. over 30 min, then incubated at 25° C. for 1 hour. The resulting solution was diluted 50-fold into each binding reaction (10 nM P2 per assay), and assayed as described above.

### 2. Results

To generate libraries of PNA polymers using DNA-templated PNA aldehyde coupling, several codon sets were tested that were predicted to have well-matched PNA:DNA base-pairing stabilities (Giesen et al. (1998) Nucleic Acids Res. 26, 5004-5006), and that minimize frameshifting by enforcing at least one mismatch when codons are misaligned on templates. Each of the nine PNA aldehyde building blocks of the sequence gvvt (where lower case letters are used to represent PNAs, and v=a, c, or g) undergo highly efficient, sequence-specific polymerization reactions with a variety of 40-base complementary DNA templates (ABBC)₁₀ (where B=T, G, or C) in the presence of NaBH₃CN to generate predominantly full-length synthetic polymer products (FIG. 3A). As shown in FIG. 3A, these polymerization reactions proceed efficiently even when templates contain five or ten copies of any one of the nine possible ABBC codons.

When an equimolar mixture of the nine gvvt PNA aldehyde building blocks was combined with a library of up to 3.5×10⁹ different DNA templates consisting of ten consecutive randomized ABBC codons flanked on either side by 22-base hairpins, an efficient conversion to species whose denaturing PAGE mobility consistent with a library of PNA covalently linked to their DNA templates (FIG. 3B) was observed.

To allow the PNA component of the library to fold prior to selection, the PNA strand of each library member was freed from base pairing with its DNA template. To accomplish this goal, the 3′ hairpin of each template was extended using a strand displacement-competent thermophilic DNA polymerase and dNTPs for 30 min at 72° C. Because this approach generates double-stranded DNA templates, it also prevented the DNA component of the resulting library from folding into conformations that may survive selection (Joyce, G. F. (2004) ANNU. REV. Biochem. 73, 791-836) independent of the PNA. Szostak and co-workers recently showed that a similar strategy successfully displaced the threose nucleic acid (TNA) strand of a TNA:DNA duplex (Ichida, J. K. et al. (2005) J. AM. CHEM. SOC. 127, 2802-3). For both single-sequence PNA-DNA hairpin conjugates (data not shown) as well as for PNA-DNA libraries (FIG. 4A), a significant shift in PAGE mobility upon treatment with DNA polymerase and dNTPs was observed. Experiments using restriction endonucleases specific for double-stranded DNA indicate that products from these displacement reactions predominantly exist in a form in which the translated PNA strand is no longer base-paired with the DNA template (see Materials and Methods), consistent with successful PNA strand displacement.

The library of translated and displaced PNAs covalently linked to their corresponding DNA templates were subjected to in vitro affinity selections (Doyon et al. (2003) J. AM. CHEM. SOC. 125, 12372-3) for binding to papain, a commercially available cysteine protease. The (gvvt)₁₀ library arising from 10 mol of starting DNA template was incubated with papain-linked beads at 4° C. for 4 hours. The beads were extensively washed to remove non-binders. The washed beads were heated to elute bound library members, then combined (without filtration) with a fresh aliquot of papain-linked beads and incubated and washed as before. In contrast with a traditional affinity selection protocol in which eluted binders are transferred to new vessels between rounds, it was found that this protocol dramatically reduced material losses between rounds without compromising the effectiveness of each round of selection (see Materials and Methods).

After four rounds of affinity selection as described above, the templates surviving selection were amplified by PCR (FIG. 4B), cloned into pBluescript, and sequenced to reveal the identity of the DNA templates (and, by inference, the identity of the PNA polymers) surviving the papain binding selection. Three of the nine sequenced clones were identical or differed only at one base, suggesting that the PNA corresponding to this sequence (designated P1) may possess papain-binding activity (FIG. 4C). Although secondary structure prediction algorithms for PNA have not been reported, when analyzed by the mFold RNA secondary structure prediction method (Zuker (2003) Nucleic Acids Res. 31, 3406-15) using a high simulated salt concentration to minimize error arising from the mostly uncharged state of the PNA backbone, the P1 sequence was predicted to form a strong stem-loop structure consisting of an eight base-pair stem and a six-base loop (FIG. 4D).

As an initial characterization of the P1 translation product, a series of enrichment experiments were carried out that were designed to compare the survival of P1 during the papain affinity selection with that of closely related or unrelated PNA-DNA conjugates. The DNA template encoding P1 was combined with a 500-fold excess of a DNA template encoding a mutant of P1, designated M1. The locations of a gggt codon predicted to lie in P1's loop and a gcat codon predicted to lie in P1's stem were swapped in M1, which was otherwise identical to P1 (FIG. 5A). The 500:1 M1:P1 template mixture was translated, displaced, and subjected to three rounds of papain affinity selection as described above. The DNA templates from species surviving the third selection round were amplified by PCR and analyzed by restriction digestion. The P1-encoding template was enriched ˜500-fold after selection relative to the M1-encoding template (FIG. 5A), demonstrating that the order of codons with P1 determines its ability to survive the selection.

To confirm that the above enrichment of P1 does not arise from an unusually poor affinity of M1 for papain, the experiment was repeated with M1 and an unrelated library sequence (designated U1). Translation, displacement, and selection beginning with a 500:1 ratio of M1:U1 DNA templates resulted in no detectable enrichment for U1 (FIG. 5A). Taken together, these results indicate that the P1 translation product survives papain affinity selection much more efficiently than either a codon-swapped mutant (M1) or an unrelated sequence (U1).

To characterize the ability of the selected synthetic polymer to bind papain in the absence of its DNA template, a portion of the P1 PNA was synthesized by solid-phase synthesis. Simplifying assumptions were made which included that (i) the predicted stem-loop region of P1 was responsible for its putative papain affinity, and (ii) the secondary amine linkages between every fourth PNA nucleotide arising from DNA-templated reductive amination could be replaced by standard amide linkages without abolishing papain binding activity. The 18-base PNA corresponding to the majority of the P1 stem-loop (FIG. 5B, expected mass=4929.5 D; observed mass=4929.7 D) was conjugated to the fluorophore BFL at its amino terminus to enable papain binding assays using fluorescence polarization. As controls, the 18-base PNA corresponding to the M1 mutant of P1 was also synthesized on solid-phase and conjugated to BFL (expected mass=4929.5 D; observed mass=4929.0 D), as well as the 18-base DNA analogue of P1 containing a 5′-amino group (FIG. 5B).

Fluorescence polarization assays in the presence of varying concentrations of papain revealed that the P1 stem-loop PNA possesses significant papain affinity. Although binding was not fully saturated at the maximum papain concentration that could be tested (70 μM), the K_{d} of the P1-papain complex was estimated to be approximately 25 μM (FIG. 5B). In contrast, neither M1 nor the DNA analogue of the P1 stem loop exhibited any detectable papain affinity. The BFL fluorophore alone also did not bind papain (FIG. 5B). These results indicate that the P1 synthetic polymer discovered from the translation and selection process described above possesses papain-binding activity. In addition, this activity is dependent on the sequence of monomers and on the structure of the polymer's backbone, but does not require the presence of the DNA template.

In order to determine if P1 bound proteins in a non-specific manner, or if it exhibited target-binding specificity, the protein-binding assays were repeated with two proteins unrelated to papain: trypsin and lysozyme. Truncated P1 PNA did not exhibit detectable affinity for either trypsin or lysozyme (FIG. 5C). These results are consistent with the hypothesis that P1 does not simply bind non-specifically to common features of proteins (such as the presence of partially exposed hydrophobic groups), but instead adopts a three-dimensional conformation that is at least partially selective for binding to papain.

In an effort to evolve a synthetic polymer with improved functional properties, a second-generation template library based on P1 was created in which three of the codons at the end of the predicted stem-loop were randomized at a total of five nucleotide positions (FIG. 6A). The corresponding DNA template library (theoretical size of 243 members) was translated, displaced, and subjected to three iterated rounds of papain affinity selection as described above. A majority (8 out of 13, or 62%) of the clones recovered from this second-generation selection are of a single sequence, designated P2 (FIG. 6A). Although three of the five randomized positions in P2 converge on the parental P1 sequence, P2 contains two new mutations: a [c→a] mutation in the stem and a [g→c] mutation in the loop. The former mutation, present in all 13 of the sequenced second-generation clones, is predicted to shorten the P1 stem and expand the loop by two bases (FIG. 6B).

The solid-phase synthesis of the 18-base PNA stem-loop corresponding to P2 and labelling its amino terminus with BFL was performed as before. Fluorescence polarization assays revealed that this truncated P2 PNA bound to papain with significantly improved affinity (K_{d}=5 μM) (FIG. 6C). In addition, binding of truncated P2 to papain was inhibited by pre-incubation with a DNA 18-mer complementary to the P2 PNA sequence, but was not inhibited by a DNA 18-mer containing the P2-complementary codons in a scrambled order (FIG. 6D), further suggesting that P2 secondary structure was required for papain binding activity.

Collectively, these results represent the in vitro evolution of a purely synthetic polymer and demonstrate that template-directed, non-enzymatic synthesis can proceed with sufficient fidelity and efficiency to support laboratory evolution. These findings also establish that mixed-sequence PNA polymers can access conformations capable of selective binding to a target protein, even when a constrained genetic code (in this case, gvvt) is used to avoid frameshifting.

The extent to which the P2 translation product was present in the initial library is unknown; it may have been underrepresented such that the initial library did not contain a sufficient number of P2 molecules to enable its emergence in the first selection. In addition, the initial four rounds of selection may not have sufficiently enriched the best papain binders to enable P2 to be represented at a detectable level within the sampled sequences, even though P2 could be readily accessed in a smaller, focused library of P1 variants. The emergence of a second-generation synthetic polymer with improved functional properties demonstrates the value of an additional round of mutagenesis, retranslation, and reselection even when theoretical library sizes (3.5×10⁹ in this case) may not exceed the number of molecules that are created in a single library.

### Incorporation By Reference

The entire contents of each of the publications, patents and patent applications cited herein are incorporated by reference into this application for all purposes.

### EQUIVALENTS

The invention may be embodied in other specific forms without departing form the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. An in vitro method for evolving a polymer having a particular property, the method comprising the steps of:
(a) producing a mixture of polymers, wherein each polymer is associated with a template oligonucleotide that encoded the synthesis of the polymer;
(b) selecting from the mixture produced in step (a) a polymer having a particular property, wherein the selected polymer is associated with the template that encoded its synthesis;
(c) obtaining information about the sequence of the template associated with the polymer selected in step (b);
(d) producing a plurality of evolved templates, each of which differs by at least one base from the template associated with the polymer selected in step (b);
(e) producing a mixture of evolved polymers using the evolved templates, wherein each evolved polymer is associated with the template that encoded its synthesis; and
(f) selecting from the mixture produced in step (e) an evolved polymer having the particular property.

2. The method of claim 1, wherein in step (a), the polymer is covalently attached to the template oligonucleotide.

3. The method of claim 1, wherein in step (e), the polymer is covalently attached to the template oligonucleotide.

4. The method of claim 1, wherein the polymer is a PNA.

5. The method of claim 1, comprising the additional step of, after step (a) but before step (b), permitting the polymer to fold.

6. The method of claim 2, wherein the polymer becomes substantially disassociated from the template.

7. The method of claim 6, wherein an oligonucleotide complementary to the template disassociates the polymer from the template.

8. The method of claim 1, wherein the property is catalytic activity, binding activity, solubility, or stability.

9. The method of claim 1, wherein the polymer produced in step (e) has a more desirable property than the polymer produced in step (a).

10. An in vitro method for evolving a polymer having a particular property, the method comprising:
(a) combining (i) a plurality of different templates, wherein each template comprises a first codon and a second codon, with (ii) a plurality of transfer units, at least one of which comprises a monomeric subunit associated with an oligonucleotide having a first anti-codon capable of annealing to the first codon of a given template and at least one of which comprises a different monomeric subunit associated with an oligonucleotide comprising a second anti-codon capable of annealing to the second codon of a given template under conditions to permit transfer units to anneal to a particular template and to permit at least one monomer subunit to become covalently linked to a different monomer subunit to produce a polymer associated with the template that encoded its synthesis;
(b) selecting a polymer having a particular property, wherein the polymer remains associated with the template that encoded its synthesis;
(c) obtaining sequence information about the template associated with the polymer selected in step (b);
(d) obtaining a plurality of evolved templates that contain a codon that differs by at least one base from the template associated with the polymer selected in step (b);
(e) combining (i) the plurality of evolved templates with (ii) a said plurality of transfer units under conditions to permit transfer units to anneal to a particular template and to permit a first monomer subunit to become covalently linked to a second monomer subunit to produce an evolved polymer associated with the evolved template that encoded its synthesis; and
(e) selecting an evolved polymer having the particular property.

11. The method of claim 10, wherein in step (a), the polymer is covalently attached to the template that encoded its synthesis.

12. The method of claim 10, wherein in step (e), the evolved polymer is covalently attached to the evolved template that encoded its synthesis.

13. The method of claim 10, wherein the polymer is a PNA.

14. The method of claim 10, comprising the additional step of, after step (a) but before step (b), permitting the polymer to fold.

15. The method of claim 11, wherein the polymer is disassociated from the template that encoded its synthesis.

16. The method of claim 15, wherein an oligonucleotide complementary to the template disassociates the polymer from the template.

17. The method of claim 10, wherein the property is catalytic activity, binding activity, solubility, or stability.

18. The method of claim 10, wherein the polymer produced in step (e) has a more desirable property than the polymer produced in step (a).

19. A method of selecting a polymer capable of binding to a target molecule, the method comprising:
(a) combining a plurality of polymers associated with oligonucleotide templates that encoded their synthesis with a solid support having the target molecule disposed thereon under conditions to permit polymers to bind to the target molecule;
(b) removing unbound polymers;
(c) disassociating the bound polymers from the solid support to produce a first fraction enriched for polymers that bind to the target molecule;
(d) combining the disassociated polymers with a fresh solid support having the target molecule disposed therein under conditions to permit polymers to bind to the target molecule;
(e) removing unbound polymers; and
(f) disassociating the bound polymers from the solid support to provide a second fraction enriched for polymers that bind to the target molecule, wherein the second fraction contains a greater proportion of polymers that bind to the target than the first fraction.

20. The method of claim 19, wherein in step (d) fresh solid support is combined with the disassociated polymer in the presence of the solid support used in step (a).

21. The method of claim 19, wherein the polymer is a PNA.

22. The method of claim 1, wherein the polymer is a non-naturally occurring polymer.

23. The method of claim 1, wherein the polymer is not a biological polymer.

24. The method of claim 1, wherein the template is an oligonucleotide.


SEQUENCE LISTING (52 sequences)

SEQ ID NO: 1 - DNA, 60 bp, Artificial Sequence
  Template Sequences-(AGTC)10 coding region
tgcgacggtataccgtcgcaattcattcattcattcattcattcattcattcattcattc

SEQ ID NO: 2 - DNA, 60 bp, Artificial Sequence
  Template Sequences-(AGTC)10 coding region
tgcgacggtataccgtcgcaagtcagtcagtcagtcagtcagtcagtcagtcagtcagtc

SEQ ID NO: 3 - DNA, 60 bp, Artificial Sequence
  Template Sequences-(ACTC)10 coding region
tgcgacggtataccgtcgcaactcactcactcactcactcactcactcactcactcactc

SEQ ID NO: 4 - DNA, 60 bp, Artificial Sequence
  Template Sequences-(ACTCATGC)5 coding region
tgcgacggtataccgtcgcaactcatgcactcatgcactcatgcactcatgcactcatgc

SEQ ID NO: 5 - DNA, 60 bp, Artificial Sequence
  Template Sequences-(ACTCAGGC)5 coding region
tgcgacggtataccgtcgcaactcaggcactcaggcactcaggcactcaggcactcaggc

SEQ ID NO: 6 - DNA, 60 bp, Artificial Sequence
  Template Sequences-(ACGC)10 coding region
tgcgacggtataccgtcgcaacgcacgcacgcacgcacgcacgcacgcacgcacgcacgc

SEQ ID NO: 7 - DNA, 60 bp, Artificial Sequence
  Template Sequences-(ATCC)10 coding region
tgcgacggtataccgtcgcaatccatccatccatccatccatccatccatccatccatcc

SEQ ID NO: 8 - DNA, 60 bp, Artificial Sequence
  Template Sequences-(AGCC)10 coding region
tgcgacggtataccgtcgcaagccagccagccagccagccagccagccagccagccagcc

SEQ ID NO: 9 - DNA, 60 bp, Artificial Sequence
  Template Sequences-(ACCC)10 coding region
tgcgacggtataccgtcgcaacccacccacccacccacccacccacccacccacccaccc

SEQ ID NO: 10 - DNA, 84 bp, Artificial Sequence
  Template Sequences-First-generation library
tgcgacggtgcgcaccgtcgcaabbcabbcabbcabbcabbcabbcabbcabbcabbcabbcggacaaggtgcgcaccttgtcc

SEQ ID NO: 11 - DNA, 84 bp, Artificial Sequence
  Template Sequences-Second-generation library
tgcgacggtgcgcaccgtcgcaagccattcatgcatbcabbcabbcatgcattcattcatgcggacaaggtgcgcaccttgtcc

SEQ ID NO: 12 - DNA, 76 bp, Artificial Sequence
  Template Sequences
tcgaattcgtacgaattcgaagtcactcatccatgcatgcactcatccagtcttttgtgcggacgatcgtccgcac

SEQ ID NO: 13 - DNA, 23 bp, Artificial Sequence
  Primer Sequences
ccgccgggatccgcaccgtcgca

SEQ ID NO: 14 - DNA, 23 bp, Artificial Sequence
  Primer Sequences
ccgccgctcgaggcaccttgtcc

SEQ ID NO: 15 - DNA, 25 bp, Artificial Sequence
  Primer Sequences
cacacaggaaacagctatgaccatg

SEQ ID NO: 16 - DNA, 84 bp, Artificial Sequence
  Template Sequences-P1 template
tgcgacggtgcgcaccgtcgcaagccattcatgcatgcacccaggcatgcattcattcatgcggacaaggtgcgcaccttgtcc

SEQ ID NO: 17 - DNA, 84 bp, Artificial Sequence
  Template Sequences-M1 template
tgcgacggtgcgcaccgtcgcaagccattcatgcacccatgcaggcatgcattcattcatgcggacaaggtgcgcaccttgtcc

SEQ ID NO: 18 - DNA, 84 bp, Artificial Sequence
  Template Sequences-U1 template
tgcgacggtgcgcaccgtcgcaagtcagtcacccaatcactcacgcatccagtcacccaaccggacaaggtgcgcaccttgtcc

SEQ ID NO: 19 - DNA, 18 bp, Artificial Sequence
  Anti-P2 DNA (complementary to P2)
gcatgcagccagtcatgc

SEQ ID NO: 20 - DNA, 18 bp, Artificial Sequence
  Anti-control DNA (scrambled codon control)
gcagtcatgcatgcagcc

SEQ ID NO: 21 - DNA, 40 bp, Artificial Sequence
  DNA Template Sequences
gvvtgvvtgvvtgvvtgvvtgvvtgvvtgvvtgvvtgvvt

SEQ ID NO: 22 - DNA, 40 bp, Artificial Sequence
  DNA Template Sequences
gcatgaatgaatgcatgcctgggtgcatgcatgaatggct

SEQ ID NO: 23 - DNA, 40 bp, Artificial Sequence; identical to SEQ ID NO: 22
  DNA Template Sequences

SEQ ID NO: 24 - DNA, 40 bp, Artificial Sequence
  DNA Template Sequences
gcatgaatgaatgcatgcctgggtgcatgcatgaatgact

SEQ ID NO: 25 - DNA, 40 bp, Artificial Sequence
  DNA Template Sequences
ggatggatgagtgggtgactgaatgagtgcatgcctgagt

SEQ ID NO: 26 - DNA, 40 bp, Artificial Sequence
  DNA Template Sequences
ggatgactggatgactgcctgaatgaatgcatgaatgaat

SEQ ID NO: 27 - DNA, 40 bp, Artificial Sequence
  DNA Template Sequences
gaatgactgcatgaatgggtggctggctgactgactgagt

SEQ ID NO: 28 - DNA, 40 bp, Artificial Sequence
  DNA Template Sequences
gaatgagtgactgaatgggtgcgtgaatgagtgagtggat

SEQ ID NO: 29 - DNA, 40 bp, Artificial Sequence
  DNA Template Sequences
ggatgaatggctggatgaatgcatggatgactggatgcat

SEQ ID NO: 30 - DNA, 40 bp, Artificial Sequence
  DNA Template Sequences
gactgaatggctgaatgggtgagtgagtgcgtgcgtgaat

SEQ ID NO: 31 - DNA, 40 bp, Artificial Sequence
  DNA Template Sequences
gcatgaatgaatgcatgcctgcatgggtgcatgaatggct

SEQ ID NO: 32 - DNA, 40 bp, Artificial Sequence
  DNA Template Sequences
ggttgggtgactggatgcgtgagtgattgggtgactgact

SEQ ID NO: 33 - DNA, 18 bp, Artificial Sequence
  DNA Template Sequences
gcatgcctgggtgcatgc

SEQ ID NO: 34 - DNA, 18 bp, Artificial Sequence
  DNA Template Sequences
gcatgcctgcatgggtgc

SEQ ID NO: 35 - DNA, 18 bp, Artificial Sequence
  DNA Template Sequences
gcatgcctgggtgcatgc

SEQ ID NO: 36 - DNA, 40 bp, Artificial Sequence
  DNA Template Sequences
gcatgaatgaatgcatgvvtgvvtgvatgcatgaatggct

SEQ ID NO: 37 - DNA, 40 bp, Artificial Sequence
  DNA Template Sequences
gcatgaatgaatgcatgactggctgcatgcatgaatggct

SEQ ID NO: 38 - DNA, 40 bp, Artificial Sequence; identical to SEQ ID NO: 37
  DNA Template Sequences

SEQ ID NO: 39 - DNA, 40 bp, Artificial Sequence; identical to SEQ ID NO: 37
  DNA Template Sequences

SEQ ID NO: 40 - DNA, 40 bp, Artificial Sequence; identical to SEQ ID NO: 37
  DNA Template Sequences

SEQ ID NO: 41 - DNA, 40 bp, Artificial Sequence; identical to SEQ ID NO: 37
  DNA Template Sequences

SEQ ID NO: 42 - DNA, 40 bp, Artificial Sequence; identical to SEQ ID NO: 37
  DNA Template Sequences

SEQ ID NO: 43 - DNA, 40 bp, Artificial Sequence; identical to SEQ ID NO: 37
  DNA Template Sequences

SEQ ID NO: 44 - DNA, 40 bp, Artificial Sequence; identical to SEQ ID NO: 37
  DNA Template Sequences

SEQ ID NO: 45 - DNA, 40 bp, Artificial Sequence
  DNA Template Sequences
gcatgaatgaatgcatgaatgggtgcatgcatgaatggct

SEQ ID NO: 46 - DNA, 40 bp, Artificial Sequence; identical to SEQ ID NO: 45
  DNA Template Sequences

SEQ ID NO: 47 - DNA, 40 bp, Artificial Sequence; identical to SEQ ID NO: 45
  DNA Template Sequences

SEQ ID NO: 48 - DNA, 40 bp, Artificial Sequence; identical to SEQ ID NO: 45
  DNA Template Sequences

SEQ ID NO: 49 - DNA, 40 bp, Artificial Sequence
  DNA Template Sequences
gcatgaatgaatggatgactgggtgcatgcatgaatggct

SEQ ID NO: 50 - DNA, 22 bp, Artificial Sequence
  DNA Template Sequences
atgcatgcctgggtgcatgcat

SEQ ID NO: 51 - DNA, 22 bp, Artificial Sequence
  DNA Template Sequences
atgcatgvvtgvvtgvatgcat

SEQ ID NO: 52 - DNA, 22 bp, Artificial Sequence
  DNA Template Sequences
atgcatgactggctgcatgcat